(19) United States
(12) Patent Application Publication
(10) Pub. No.: US 2013/0305170 A1
(43) Pub. Date: Nov. 14, 2013

(54) SYSTEMS, TECHNIQUES AND MECHANISMS FOR DISPLAYING ONLINE ADVERTISEMENTS IN A VIEWABLE AREA OF A WEB BROWSER

(71) Applicant: ZEDO, INC., San Francisco, CA (US)

(72) Inventors: Roy de Souza, New York, NY (US); Joseph Jacob, San Francisco, CA (US)

(21) Appl. No.: 13/873,531

(22) Filed: Apr. 30, 2013

Related U.S. Application Data
(60) Provisional application No. 61/687,830, filed on May 2, 2012.

(51) Int. Cl. G06F 3/0485

(52) U.S. Cl. CPC G06F 3/0485
USPC 715/760

(57) ABSTRACT

It is desirable to have an advertisement requested and impression recorded when a user actually sees an entirety of an ad. It is desirable to have the advertisement requested and impression recorded if a user scrolls down a webpage and all processes and functions required to make the ad unit visible on the webpage are completed and when the advertisement's location corresponds to the viewable area of a webpage. That is, the ad could be requested and the impression should be recorded when an ad unit is in a visible viewing area. It is also desirable to provide for greater viewer attention to the ad and for greater control by the advertiser over the manner in which advertising is presented. One aspect is solves these needs by generating, transmitting, and presenting an ad on a webpage when a user scrolls down the page or if a triggering event is detected.

### CROSS REFERENCE TO RELATED APPLICATION

The present application claims the benefits of and priority, under 35 U.S.C. §119(e), to U.S. Provisional Application Ser. No. 61/687,830 filed May 2, 2012, entitled “Ad Unit Display on a Web Page,” which is incorporated herein by reference in its entirety.

### FIELD

An exemplary embodiment of the invention relates to online advertising. Even more specifically, an exemplary embodiment relates to displaying online ad units in a webpage in a more efficient manner. Even more specifically, an exemplary aspect relates to displaying online ad units in a webpage in a manner that at least allows more accurate tracking of ad impressions.

### BACKGROUND

An ongoing goal in the online advertising industry is finding ways to more accurately record ad impressions. That is, finding more efficient and accurate ways to count each time a viewer of a webpage actually sees an entire ad unit. For example, counting an impression for an ad that is served on a page load in a browser is not always accurate since the ad may not be seen and/or be entirely visible to the viewer, and therefore should not count as an impression.

### SUMMARY

It is desirable to have the advertisement requested and impression recorded only when a user actually sees an entirety of an ad. For example, it would be desirable to have the advertisement requested and impression recorded only if a user scrolls down a webpage and all processes and functions required to make the ad unit visible on the webpage are completed and when the advertisement's location corresponds to the viewable area of a webpage. That is, the ad should be requested and the impression should be recorded when an ad unit is in a visible viewing area. It would also be desirable to provide for greater viewer attention to the ad and for greater control by the advertiser over the manner and length in which advertising is presented to viewers of a webpage.

Another aspect of the invention is directed towards systems, methods, and techniques for generating, transmitting, and presenting an ad unit on a webpage when a user scrolls down the page or if a triggering event is detected.

Even further aspects of the invention relate to detecting a scroll event and triggering one or more subsequent actions based on this detection.

Additional aspects of the invention relate to detecting a “page fold” in a webpage, and triggering one or more actions based on scrolling past this fold. The terms “page fold” and “below the fold” in the web browser context are taken from the newspaper industry where newspapers were often folded and displayed to customers so that only the top half of the front page is visible. Thus, an item that is “above the fold” is content the person would see when the paper is stacked and displayed to the customer. However, content that is “below the fold” was content on the newspaper that would be face down when the papers were stacked with the name of the newspaper visible to the user. This concept of “above the fold” and “below the fold” also are known as “above the crease” and “below the crease,” with these terms having been carried over to the internet and internet browser industry where content in a webpage that is visible upon loading is content that is “above the fold” and content that is not visible until the user scrolls down is content that is “below the fold.”

In accordance with one exemplary embodiment, the system requests an advertisement and records an impression for an ad served not on page load, but only if the user scrolls down past the page fold and all processes and functions required to make the ad unit visible on the page are completed, then the ad would be viewable by the user. Thus, this results in a system recording an impression only if the ad unit, and hence the ad, is in the visible viewing area as a result of scrolling down a webpage.

In accordance with another exemplary aspect, a client browser may receive, from an ad server, an ad unit and pre-defined methods to collect, transmit, receive, and generate information to display the ad unit in response to the user's scrolling down the webpage, at a position as ascertained by the involved systems. The ad unit may also be defined to appear on a particular percentage of page scroll, or when the display of a “below the fold” position has been reached in response to the user scrolling down the webpage.

In yet another exemplary aspect, the techniques disclosed herein may further utilize one or more of the following: Measuring “above the fold” portions of a webpage; defining a size and location for the ad unit on the webpage; displaying ads based on targeting data collected from the client computer; adding extra display area to the webpage to accommodate the ad unit; no longer displaying the ad when the user scrolls back up; no longer displaying the ad when the user scrolls down further and instead displaying a different ad; hiding elements of the webpage behind the ad unit; and/or placing cookies on the client machine.

For example, the ad unit may slide into the viewing area and remain on the screen in a predetermined location while the viewer scrolls down the page, and then slide off the screen when a user scrolls back up. This provides for greater viewer attention to the advertisement and for greater control by the advertiser over the manner and length in which advertising is presented to viewers on a webpage. Doing so permits advertisements to be presented to users while limiting, for example, any associated negative impacts on user productivity.

In accordance with one exemplary embodiment, these and other features may be accomplished with the use of an ad tag, in combination with one or more of a JavaScript and other HTML elements, such as the use of the iframe tag, interactions with ad servers and cookies. This is currently supported by all major browsers; the iframe tag specifies an inline frame. An inline frame is used to embed another document within a current HTML document.

In accordance with another exemplary embodiment, the browser and the operating system are located on a client machine. The browser, operating system and client machine can be, for example, any commercially available unit that includes, for example, one or more processors, memory, and storage, as well as one or more browsers including, for example, Chrome®, Firefox®, Internet Explorer®, or the like. In general, the systems, techniques, and methodologies described herein will be described in relation to a client machine and associated browser, however it should be appreciated that the techniques disclosed herein can also work on a mobile platform, such as a smartphone and associated browser, in a Smart TV type of environment were a television includes a browser or internet browsing capabilities, or in general on any platform that is capable of supporting web browser functionality.

In general, a webpage is prepared by one or more publishers, and written in a hypertext language, which is then displayed in a viewing area of the browser, and is constructed by loading one or more fetched files from a webserver(s) into the web browser. In accordance with one exemplary embodiment, a JavaScript tag is placed in the hypertext language of the webpage, so as to fulfill the functionality of some of the exemplary techniques disclosed herein. It should be understood that various methods could be used to retrieve information contained in this tag to serve the end purpose of serving the ad.

In accordance with one exemplary embodiment, the client machine is either wired or wirelessly connected to the internet, and one or more of the webservers and ad servers use conventional techniques for transferring and/or serving content or information, including ads. Furthermore, it is presumed that a user is actively viewing the webpage while invoking the various functions, techniques, and processes associated with displaying an ad in a browser.

Another exemplary embodiment is directed toward detecting a transition across the page fold, and serving one or more ads based thereon. The ads can, for example, be animated and appear from one or more of the right, left, top, bottom, or diagonally into the viewable area of the browser. Similarly, in a similar way to shuffling a deck of cards, the plurality of ads can be served with the topmost ad being shuffled back into the “deck” and the next ad being displayed in a shuffle-like manner.

In accordance with another exemplary embodiment, and upon the detection of an appropriate trigger, a video or video ad can be displayed where the video or video ad encompasses substantially or all of the browser window, or could optionally fill the full screen of the display associated with the client computer or client device, such as a computer display, smartphone display, tablet, on a Smart TV, etc.

In accordance with one exemplary technique, architecture is described for the transmission and recording of information required, and subsequent setting up of the mechanism required to fulfill ad serving. As will be discussed later in connection with some of the exemplary figures, the transmission and recording of information and initial process(es) that allows for the subsequent ad serving when a user interacts with the client and browser are discussed. More specifically, the technique can begin with a user requesting and receiving a webpage via a browser in a client computer connected to the internet. The server(s) sending the webpage can also send a JavaScript ad tag contained in the webpage which is received by the client browser on the client computer. The ad tag locates the server corresponding to a URL stored in the tag and requests and loads additional JavaScript (client-side JavaScript) required to complete the subsequent operations. The client-side JavaScript can be the ad code that is downloaded by the ad tag. The JavaScripts involved may be substantially similar to each other in design and functionality, and may be present when needed. The JavaScript contains, for example, external variables with pre-defined values and settings to implement the techniques discussed herein. These external variables can be used by the publisher (serving the webpage) to define conditions surrounding how and when the ad is to be served.

This client-side JavaScript checks whether the client machine, its operating system, the browser, the browser version, and the viewport area (the visible area of the canvas) are compatible for implementing one or more of the techniques discussed herein. In accordance with one exemplary embodiment, the viewport area is the area seen by the user on the screen or display at a given time which is typically not the entire webpage, but only a part of what the operating system is showing on the display. In other words, it is the portion that the viewer can see in the browser window at the time the ad is called. For example, a browser width and height are detected (see attached appendix). If any of these are not suitable for the ad mechanisms to progress, the system may not show the ad unit and the ad will not be served. However, if all of the above componentry is verified as compatible, the client-side JavaScript can ascertain if there are functions related to a (browser scroll event) contained in the webpage HTML set by the publisher. If functions related to a browser scroll event are detected, these browser scroll event functions can be stored as a variable inside a browser scroll event function. If no browser scroll event functions have been set by the publisher, the browser scroll event is set as the only available one.

Again, if all components are verified as compatible, simultaneously, the client-side JavaScript can try to locate and check whether there are any publisher cookies on the client machine. The cookies can be identified through conventional naming scheme(s). If existing publisher cookies are detected on the client machine, the values contained in these cookies can be recorded and compared with external variable values defined in the client-side JavaScript. Frequency cap is one of such values. If the comparison concludes that the frequency cap value defined by the client-side JavaScript has been met, then the ad serving process is unnecessary for the client machine in this instance and the ad unit will not be shown. However, in the absence of a publisher cookie, the frequency cap check may not be conducted due to lack of necessary data. In this scenario, or in the case of the frequency cap not being met, the client-side JavaScript can conduct two further simultaneous processes.

The first process involves receiving and setting up cross domain transport using another JavaScript procured from, for example, the ad server. The cross domain transport may be set up using “post message method” or “flash transport method” depending on, for example, the client browser. After the cross domain transport has been set up, a non-visible iframe can be created on the webpage by the client-side JavaScript. The non-visible iframe is a space where the ad will be placed.

The second step conducted simultaneously involves ascertaining the “below the fold” value. This value may be defined in the external variables. For example, the publisher website owner may only want to show an advertisement only when the below the fold is crossed by the user. Other publishers may require that the user scroll down at least 33 percent, or 50 percent, or some other percentage, down the page. The value may also be determined or specified based on a number of pixel(s). Another factor that may be considered is whether the top or the bottom of the ad unit crosses the threshold value. These values and implementation details are requested by the ad publisher. It may be noted here that when a user scrolls up the webpage and the below the fold value changes, depending on where the trigger or threshold value is, the ad can optionally slide back in, close, or otherwise disappear. (See appendix for exemplary code)

If it is not defined, the client-side JavaScript can ascertain the height of the viewport area and set the below the fold value as, for example, one pixel after the final pixel of the ascertained height. This value is set to the client-side JavaScript. Once the value has been ascertained, or is deemed to be correctly pre-defined in the external variables, the client-side JavaScript can create an ad unit iframe outside the viewport area in a position corresponding to the external variable values that define its final position on the page. One exemplary goal of the techniques disclosed herein is to place the ad iframe outside the viewport area so that it cannot be seen and then “slide” into view when the right trigger(s) are met. Other HTML elements, including supporting images, can also be loaded with the ad unit iframe when it slides into view. This completes the process of setting up the mechanism for fulfilling the ad serving process.

Next, an exemplary technique is discussed that takes place if the user scrolls the webpage. In accordance with one exemplary embodiment, assuming all the above processes have been completed, following technique begins when the user scrolls the webpage. More specifically, the client-side JavaScript performs browser scroll event functions, including the functions stored earlier. Generally, previously stored on-scrolled events should be followed and performed when scroll is invoked by the user. (See open ad code attached hereto). For every browser scroll event, the client-side JavaScript detects the present Y-axis position value and compares it to the below the fold value determined previously. Other browsers scroll event functions, earlier detected and stored in a browser scroll event function are also fired for every browser scroll event, but prioritized in a manner such that it is second to the browser scroll event function. The combined browser scroll event functions perform at browser scroll events as long as the page is active in the browser.

If the ascertained (below the fold) position is met, the previously created ad unit iframe will request a specific ad server for one or more ads. The ad server may use one of a multitude of techniques to gather targeting information for the environment in which the user, the client machine and the associated elements operate.

This information can be used by the ad server to invoke functions associated with its decision engine, that writes the algorithms, just like the best available ad to serve in response to a request. The decision engine can use the request, its contents and associated parameters to select an ad that is best suited to function on the client machine, while fulfilling other requirements associated with the ad serving. The decision engine can involve multiple pre-scheduled match processes. In the decision engine, processes run, for example, every few minutes and create ad-algorithm files which are copied to one or more ad servers. It also writes the index/mapping files that help the ad server decide which algorithm files should be fetched depending on a request.

Once the decision engine and the ad server determine if a suitable ad is available, it provides this decision to the ad server. This decision could mean that either an ad is present and is ready to be sent to the client machine, or that no ad is available. If there is an ad available, an impression is counted for the ad by the ad server. The decision, i.e., whether a suitable ad is available or not, can be simultaneously sent by the ad server, such as via an HTTP response, to the previously set up cross domain transport using the non-visible (hidden) iframe.

Next it is determined whether the decision is yes (and available) or no (not available). If a suitable ad is available, the client-side JavaScript populates the previously created ad unit iframe with the available ad. The ad unit iframe is simultaneously revealed on the viewport area. The manner in which the ad unit is displayed is controlled by external variables in the client-side JavaScript (See reload iframe code appended hereto).

If a suitable ad is not available, an ad unit is not shown on the webpage and the browser scroll event function can be disabled, although the other browser scroll event functions can be maintained. Generally, if there is no ad available, this system does not want to show an empty ad spot.

Assuming an ad is available, a new cookie can be set on the client machine to indicate that an advertisement is being shown (or a note is made that the ad is being shown). As noted above, the ad iframe unit is shown in the visible area (viewport area) of the browser when the ad is served. (See open ad code appended hereto).

The user may close the ad unit by virtue of scrolling back up to a position on the webpage above the below the fold position thereby causing the ad unit to disappear from the viewport area. If the closed button on the ad unit is invoked by the user, a series of methods may be used to make the user aware of the existence of the ad unit, such that the user may invoke it again.

Ad serving processes can be dependent on a variety of systems in the larger online advertising ecosystem, each with their own substitutions, alterations, and methods of functioning. The ad server discussed above, may be subject to such other systems in the ad serving ecosystem.

In accordance with another exemplary embodiment, a browser scroll event can be configured to fire or triggered one or more action(s) when the user repositions the scroll box in the scroll bar of the browser.

In a webpage, the publisher can use the browser scroll event to achieve a desired effect when scroll is invoked. Typically, the browser scroll event can contain only one function, and the browser can recognize and perform typically one browser scroll event request in a page. However, embodiments discussed here make it possible to dynamically combine multiple browser scroll event functions in a single browser scroll event request.

In accordance with one exemplary embodiment, the external variables are values defined in the client-side JavaScript. One example of an external variable is the variable that defines the Y-axis position. In this example, the Y-axis position (“below the fold” position) is 950 pixels. This means that when the client-side JavaScript determines that 950 pixels of page height is reached, the subsequent processes will start. While in this exemplary embodiment the Y-axis position is 950 pixels, it should be appreciated that this Y-axis position can be of any value.

In accordance with another exemplary embodiment, one exemplary ad format shows one video ad in the body content of a webpage by appearing in-between the text of the webpage in a manner that pushes the rest of the text below the ad, when the scroll position at which the ad format is to appear is reached. More specifically, the ad unit's code could be present in the webpage code. The ad unit's “push down effect” plays out immediately upon the ad unit coming into the viewport area of the browser. The video ad contained therein can immediately start playing in, for example, a mute or unmuted mode. When the publisher page with the ad code is requested by the browser on the client machine, the exact position, on the page, where the ad unit is to appear can be determined. A browser scroll event function is fired (triggered) when the user starts scrolling. On every scroll event, the function checks if the required viewport area (contained in the ad unit) has been successfully met. If yes, then the ad unit is expanded until the specified height of the ad, while displacing the on-page body text below it. If the scroll is invoked again, and the ad unit goes out of view, the video can, for example, pause.

While the ad is playing in the ad unit, the user may mouse over the ad unit to invoke sound. On click, the video can be played at full screen (with sound) on the client's machine or computer. While in full-screen, the user may also minimize the video to bring it back to its original state in the ad unit on the page. Once the video is done playing, the expanded ad unit can collapse, and a leave-behind replay section can be left in place of the ad unit. The user can then, if they chose, replay the ad.

Ad Tag—InRead Ad Format

<script type=“text/javascript”>
var zd_parent=“homepage-center-inner”;
var vast_domain=“http://d.domain1.com/”;
var zd_network = “749”;
var zd_channel = “4511”;
var zd_dim = “10”;
var zd_pubid = “386”;
var zd_width=“500”;
var zd_height=“400”;
var zd_fullscreen=“1”;
var zd_close=“1”;
var zd_freqcap = 5;
</script>
<script type=“text/javascript” src=“http://c5.domain1.com/c5/frd.js”>
</script>

Details of the Variable Used

var zd_parent—contains the ID of the publisher parent container.
var vast_domain—domain of the ad tag.
var zd_network—customer ID of the ad tag
var zd_channel—channel ID of the ad tag
var zd_dim—dimension ID of the ad tag
var zd_pubid—publisher ID of the ad tag
var zd_width—ad width
var zd_height—ad height
var zd_fullscreen—if set to 1 will allow fullscreen otherwise not. Default 1
var zd_close—close bar will be shown if set to 1. Default 1
var zd_freqcap—number of times the ad has to expand on load.

The above tag can be placed where the ad is required or can be placed at the end with the zd_parent (identification of parent publisher container specified). Note, that if the zd_parent is present then the width of the ad will be the width of the zd_parent ID, otherwise zd_width will be taken.

Even more specifically, and in accordance with this exemplary embodiment, when the publisher page with the above ad-tag is hit, a JavaScript is executed. All of the above variables are validated. If not present, a default value can be taken. This forms the ad tag with the above variables. The ad tag could also be compatible with the video ad serving template (VAST) certification. The system then checks if zd_parent is present, if not an InRead div container is added where the tag is placed.

Next, an “on scroll” event is fired when the user starts scrolling. During this process, a function is called to insert the InRead div container at the center of the zd-parent ID specified. Later, the system checks if the inserted InRead div is in view or out of view. A function is called in the on scroll event which determines the value of the in view-out of view determination and stores this in a variable. If in view is returned, then variable can be set to true, otherwise it will set to false. This process can be repeated every time the user scrolls.

If the function returns true, then the ad is animated/expanded until the specified height of the ad is reached. At this moment, and also if the user scroll and the function returns to false, then the ad will not play unless the function returns to the true value. The ad is played/paused when the function returns true/false values. The playing and pausing of the ad can be handled by, for example, flash based on the function that returns the true/false value.

Next, in accordance with one exemplary embodiment, flash calls a function when the video finishes which calls the animation function to close the container div and directs the placement of a replay ad bar. If replay is selected, the above techniques are repeated. Optionally, a cookie can be maintained that tracks number of instances that the ad has been displayed which is incremented accordingly. On each page hit, a frequency cap count can be compared with a cookie value and provided the cap has not been met, the replay ad bar can be shown.

An exemplary process of the above technique includes: 1. Publisher page hit, 2. InRead script is executed, 3. Tag variable are validated, 4. Default value are assigned if any variable is not defined, 5. Vast ad tag is formed based on the ad tag variable, 6. zd_parent is checked. If not present InRead ad div is inserted where tag is placed, 7. User scrolls and onscroll event is fired, which inserts InRead ad div exactly at the center of zd_parent id, 8. Once the InRead div is present it checks whether it is in-view/out-of-view, 9. If in-view, the div is animated to the height specified and ad plays, 10. Ad will play/pause if when on scroll it gets in-view/out-of-view, 11. Flash will make a function call once the ad video finishes. Which will again call the animation function to close the InRead div and show replay ad, and 12. Onclick of Replay the above process of animation/play/pause of ad is repeated.

In accordance with another exemplary embodiment, a shuffle ad unit can show, for example, two or more, here three, ads that can be of equal height and width, using a rotating “shuffle” effect, on a webpage where the ad unit's code is present and the ad is being served. While this exemplary embodiment has comparably sized ads, it is to be appreciated that the ads could be of differing height and/or width.

More specifically, an exemplary embodiment of the shuffle ad unit operates when a publisher page with the shuffle ad code is requested by the browser on the client machine, and the ad format utilizes a function to rotate or shuffle the ads when, for example, the ad unit is completely in the viewport area. The function can perform a check with every scroll that is performed on the page to see if the ad unit is in the viewport area or not. If the ad is in the viewport area, the ads can rotate. If not, the rotating effect can be paused and will not start until the ad unit comes into the viewport area. If the ad unit is deemed to be in the viewport area, the rotating “shuffle” effect of the ad format plays out, and all three ad images continue shuffling in a loop until the ad unit is no longer in view. The ad unit may be set to shuffle each ad image horizontally, diagonally, and/or vertically, or from left to right or right to left and/or at any angle. If the user moves their mouse cursor over any of the ad images, the system can, for example, arrange all three images in an overlapping cascade effect. In this state, each ad image can be brought forward upon mouseover. The animation effects included in the shuffle ad can depend on the client machine, browser capabilities, and the like.

If the ad unit comes into the viewport area, and then is scrolled out of the viewport area, then the rotating effect can be stopped until the ad unit comes back into the viewport area. The first time an ad image is visible to a user, an impression can be tracked and details sent, for example, to the ad server. This tracking can be performed once per ad image the first time, utilizing, for example, the general impression tracking mechanisms that are used in ad serving. This will be appreciated based on the discussion of the various embodiments discussed herein, this shuffle effect could be used with any one or more of the ad display techniques presented herein.

The present disclosure can provide a number of advantages depending on the particular aspect, embodiment, and/or configuration.

These and other advantages will be apparent from the disclosure and discussion herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “module” as used herein refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE FIGURES

The exemplary embodiments will be described in detail, with reference to the following figures, wherein:

FIG. 1 illustrates an exemplary operational environment according to an exemplary embodiment of the invention;

FIG. 2 is a flowchart illustrating an exemplary method for detecting a scroll event according to an exemplary embodiment of the invention;

FIG. 3 is a flowchart illustrating an exemplary method for detecting a page fold according to an exemplary embodiment of the invention;

FIG. 4 is a flowchart outlining an exemplary method for checking compatibility according to an exemplary embodiment of the invention;

FIG. 5 is a flowchart illustrating an exemplary method for displaying an ad according to an exemplary embodiment of the invention;

FIG. 6 is a flowchart illustrating a further exemplary method of displaying an ad according to an exemplary embodiment of the invention;

FIGS. 7-9 illustrate an exemplary technique for displaying an ad according to an exemplary embodiment of this invention;

FIGS. 10-12 illustrate a second exemplary technique for displaying an ad according to an exemplary embodiment of this invention;

FIGS. 13-15 illustrate a third exemplary technique for displaying an ad according to an exemplary embodiment of this invention;

FIGS. 16-20 illustrate a fourth exemplary technique for displaying an ad according to an exemplary embodiment of this invention;

FIG. 21 illustrates an exemplary method for displaying full screen video according to an exemplary aspect of this invention; and

FIG. 22 is a flowchart illustrating an exemplary method for triggering a full screen or substantially full screen video or animation according to an exemplary embodiment of the invention.

In the appended figures, similar components and/or features may have the same reference label. Furthermore, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

For purposes of explanation, numerous details are set forth in order to provide a thorough understanding of the embodiments of the present invention. It should be appreciated however that the present invention and disclosed embodiments may be practiced in a variety of ways beyond the specific details set forth herein. Furthermore, while the exemplary embodiments illustrated herein show some of the various components of the system collocated, it is to be appreciated that the various components of the system can be located at distant portions of a distributed network, such as a communications network, node, and/or the Internet, or within a dedicated secured, unsecured, and/or encrypted system and/or within a cloud computing environment.

Thus, it should be appreciated that the components of the system can be combined into one or more devices, or split between devices, such as a computer, a computing device, a server, or the like. As will be appreciated from the following description, and for reasons of computational efficiency, the components of the system can be arranged at any location within a distributed network without affecting the operation thereof. Similarly, one or more of the functional portions of the system could be distributed between one or more computing devices.

Furthermore, it should be appreciated that the various links 5, including any communications channel(s) connecting the elements can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute and variations thereof, as used herein are used interchangeable and include any type of methodology, process, technique, mathematical operational or protocol.

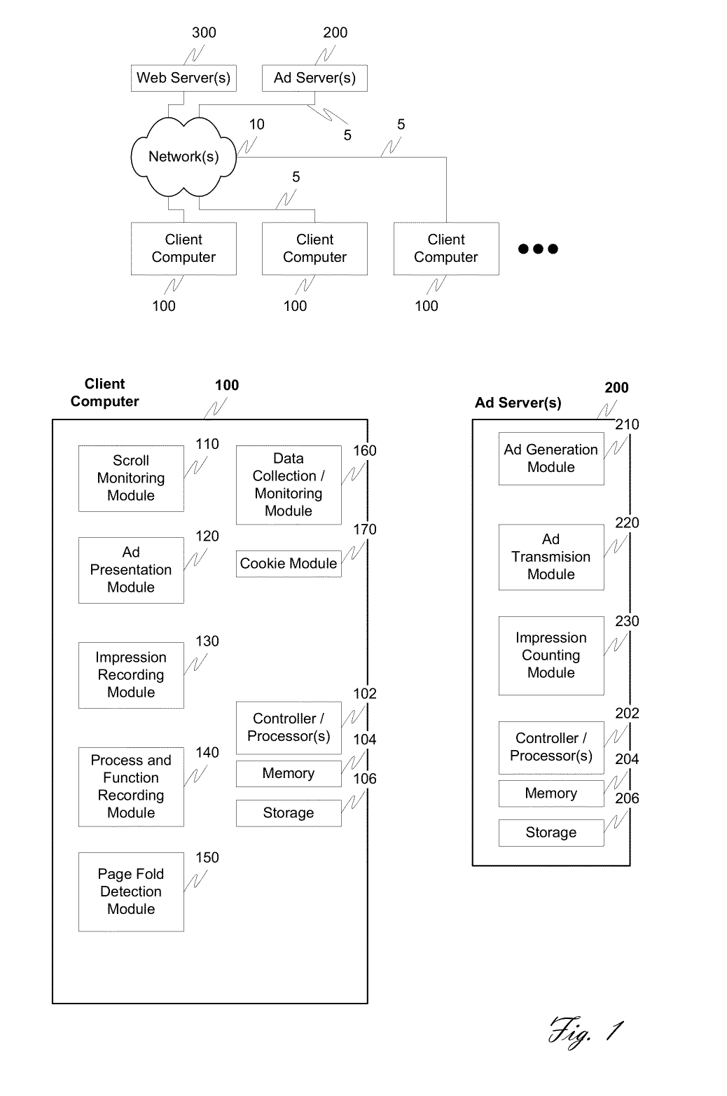

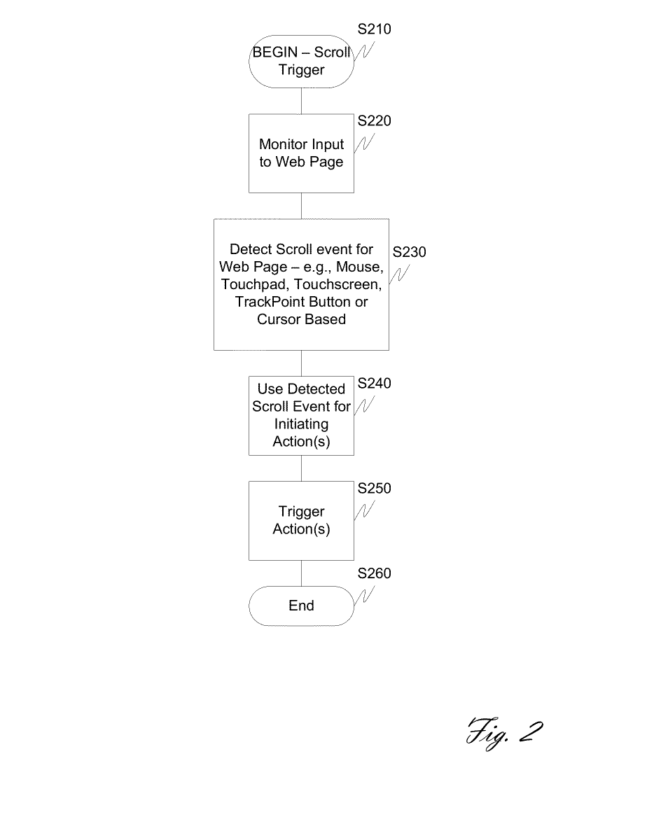

FIG. 1 illustrates an exemplary operational environment in which the techniques disclosed herein may operate, which includes one or more client computers 100, one or more web servers 300, and one or more ad servers 200, interconnected via one or more networks 10 and links 5. While an exemplary embodiment will be discussed where the web servers 300 and ad servers 200 are illustrated as separate components, it should be appreciated that these elements could be combined and hosted from the same server.

An exemplary embodiment of the client computer 100 compromises: a scroll monitoring module 110, an ad presentation module 120, an impression recording module 130, a process and function recording module 140, a page fold detection module 150, a data collection/monitoring module 160, a cookie module 170, controller/processor 102, memory 104 and storage 106, as well as conventional and well known componentry.

An exemplary embodiment of the ad server 200 compromises an ad generation module 210, an ad transmission module 220, an impression counting module 230, controller/processor 202, memory 204, storage 206, as well as conventional and well known componentry.

In operation, and in accordance with one exemplary embodiment, when a user requests a scroll event in a webpage, this scroll event can be used a trigger for performing or initiating one or more actions. More specifically, and in cooperation with the scroll monitoring module 110, controller 102, memory 104 and storage 106, input is received from a user, such as via a mouse, keyboard, trackpad, or in general from any input device, with the input being detected by the scroll monitoring module 110. The scroll monitoring module 110 can also include a sensitivity module such that the amount of scroll before the trigger is initiated can be controlled. This sensitivity can be based on, for example, one or more of pixels, a percentage of page content changed based on the scroll or an amount of change in the content displayed on the webpage, and the amount of scrolling requested by the user. As will be appreciated, the triggering of one or more actions can commence immediately upon the threshold amount of scroll being detected, and can also include a time delay such that the one or more actions are triggered after, for example, a certain number of seconds or fractions of seconds have elapsed. As will be discussed later in relation to an exemplary embodiment, this scroll trigger can also be used to initiate display of one or more ads in the webpage.

It should further be appreciated this scroll monitoring module 110 can detect this scroll event in any number of ways including, but not limited to, from the scroll wheel on a mouse, from a change in the slider-bar position within the webpage, from input from the page up/page down buttons on a keyboard, based on user input from a touch screen, based on user input from a trackpoint button, based on user input from one or more cursor buttons, or the like. In general, the manner in which the scroll command is received is agnostic to the operation of the techniques disclosed herein.

In accordance with another exemplary embodiment, and in cooperation with one or more of the page fold detection module 150, controller 102, memory 104 and storage 106, the client computer 100 is able to determine when a page fold is encountered. As will be appreciated, there can be numerous page folds within a webpage and the exemplary technique is capable of operation when a page fold is encountered as a user scrolls down a webpage, as well as when a page fold is encountered when a user scrolls up a webpage.

More specifically, and in accordance with an exemplary technique, the page fold detection module 150 monitors the position of the webpage. In accordance with an exemplary embodiment, it is assumed that when a webpage is loaded, the upper most portion of the webpage is displayed, and that a user would need to scroll down, and thus encounter a page fold, to see additional content. However, it should be appreciated, that a user could “land” somewhere in the middle of a webpage in which case there may be, for example, page folds above and below the content that is initially presented to the user.

Therefore, as a user navigates through content on a webpage, the page fold detection module 150 detects a transition across a page fold. Similar to the above-described embodiment, this transition can also be assigned a threshold value such that, for example, either a certain number of pixels above or below a page fold, or a certain percentage of the “next page” is displayed before the page fold detection module 150 triggers one or more actions. In accordance with one exemplary embodiment, the action is not triggered until at least 50% of the “next page” is being displayed to a user. In accordance with another exemplary embodiment, as soon as the user displays one line worth of content in the “next page,” one or more actions are triggered. As discussed, this triggering of actions can occur every time a page fold is encountered or, for example, in cooperation with the process and function recording module 140, can be performed a number of times up until a threshold is met. It should further be appreciated, again in cooperation with the process and function recording module 110, that the same action need not be triggered upon crossing a page fold, but rather the same action could be triggered, or different action(s) triggered as, for example, specified in one or more parameters associated with the webpage. In accordance with an optional embodiment, the assigning of these actions could also be based on user preferences such that the user specifies which action(s) are to occur upon encountering one or more page folds.

As will be appreciated, information regarding the detection of a scrolling event and the detections of actions triggered based on the encountering of a page fold could also be collected and stored in the data collection/monitoring module 160 which could optionally be forwarded to one or more of the web servers 300 and ad servers 200.

In accordance with another exemplary embodiment, and assuming device, operating system, browser and version compatibility, as well as a viewport area check, the ad presentation module 150, cooperating with one or more of the impression recording module 130, process and function recording module 140, data collection/monitoring module 160, cookie module 170, controller/102, memory 104, storage 106, as well as one or more elements within an ad server 200 including the ad generation module 210, ad transmission module 220, impression counting module 230, controller 202, memory 204 and storage 206, displays one or more ads to a user via a web browser based on criteria being met. Here, and in accordance with one exemplary embodiment, the criteria is the detection of a scroll event, as discussed previously.

More specifically, the client computer 100 requests a webpage from, for example, web server 300. The web server 300 serves the webpage, via the one or more networks 10 and links 5, to the client computer 100, which in cooperation with a display controller (not shown), controller 102, memory 104 and storage 106 displays content of the requested webpage in a web browser. This webpage can include a tag that loads a client-side JavaScript in the client computer 100. This client-side JavaScript, in cooperation with the process and function recording module 140 and controller 102, can check compatibility of one or more of the client computer 100, operating system compatibility, browser and version compatibility, as well as specifics regarding the viewport area. If the process and function recording module 140 determines client computer 100 is compatible, an ad serving routine can be initiated. However, if there are compatibility problems, the JavaScript can be disabled and no further action taken.

Assuming compatibility of the client computer 100, and in cooperation with the ad presentation module 120, scroll monitoring module 110, data collection/monitoring module 160, cookie module 170, controller 102, memory 104 and storage 106, a determination is made as to whether there is an existing publisher cookie on the client computer 100, for example, stored in memory 104 and/or storage 106. If there is an existing publisher cookie on the client computer 100, a determination is then made, in cooperation with the impression recording module 130, cookie module 170, controller 102, memory 104, and storage 106, whether a frequency cap has been met. If a frequency cap has been met, operation ends and no ads are displayed. However, if the frequency cap has not been met, and in conjunction with the page fold detection module 150, a determination is made of the below the fold value with this value having being updated in the JavaScript running in the client computer 100 if a page fold has been encountered. Similarly, if an existing publisher cookie is not found on the client computer 100, control continues to determine the below the fold value.

In parallel with these operations, a determination is also made as to whether the client computer 100 is already using the scroll event function which detects this transition over a page fold. If the client computer 100 is already using this scroll event function, the existing browser scroll event function is stored as a variable inside the browser scroll event function. Next, the client-side JavaScript is updated and an ad unit iframe is optionally created outside the browser viewport area, it is to be appreciated however that the iframe could be loaded in the viewport area.

However, if the browser is not using the scroll event function, the client side JavaScript running on the client computer 100 is updated and then the ad unit iframe is created outside the browser viewport area.

In conjunction with one or more of these actions, a cross-domain transport is also setup and a non-visible iframe is also created on the webpage. In accordance with some of the embodiments discussed herein, the ads will be presented in conjunction with an iframe tag, however it should be appreciated that other techniques could also be used for the presentation of the ad. For serving video ads, a VAST tag could optionally be used in conjunction with, for example, a Flash or non-Flash based code to play the video.

The JavaScript then monitors the browser for the user invoking the scroll function. And if a below the fold position is displayed in the browser to the user, the ad presentation module 120 requests an ad from the ad server 200, and specifically the ad generation module 210. The ad server 200, and in particular the ad generation module 210, determines if the ad is available, and if the ad is available, the impression counting module 230 counts the impression. Next, and using the cross-domain transport hidden frame, and assuming the ad is available, the ad will be displayed as discussed hereinafter.

Alternatively, if the ad is not available, an impression is not been counted by the impression counting module 230, and the ad transmission module 220 does not send an ad to the client computer 100 which can then optionally disable the scroll event function.

Assuming the ad is available, and in cooperation with the ad presentation module 120, the ad iframe is populated with the ad and optionally a cookie set on the client computer 100. The ad iframe unit is then shown in the visible area of the browser.

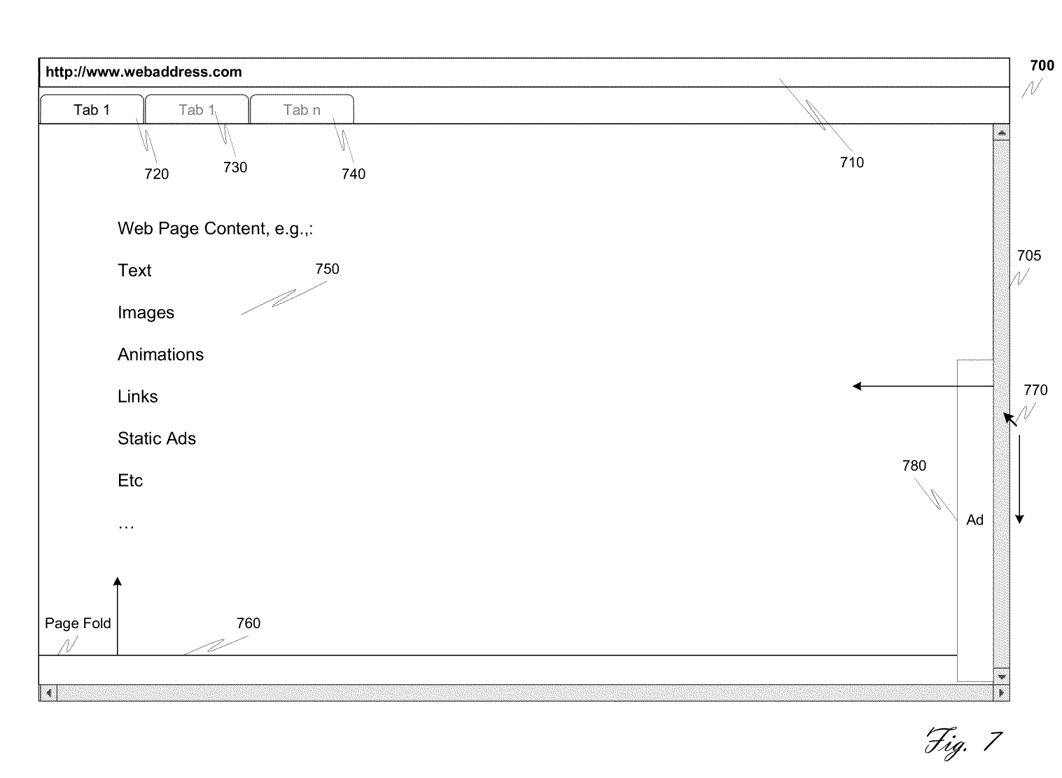

As will be discussed hereinafter, use of the iframe and iframe tag allows several special ways of presenting an ad to the user. FIGS. 7-20 illustrate some of these exemplary methods of presenting an ad to the user, where the presentation of the ad is animated and appears “on top of” the underlying content being displayed on the webpage.

More specifically, FIGS. 7 through 9 illustrate an exemplary animation where an ad 780 appears from the right-hand side of the web browser. More specifically, FIG. 7 illustrates an exemplary web browser 700 that includes, for example, an address bar 710, an active tab 720, optionally one or more inactive tabs 730 and 740 as well as webpage content 750 including, for example, one or more of text, images, animations, links, static ads, and the like.

Here, the user using cursor 770, is utilizing the scroll bar 705 to scroll down through the web page content 750. Upon the user scrolling down, the page fold 760 (illustratively shown as a black line, however is typically not visible in a webpage, but is shown simply for illustrative purposes) is detected. Upon detection of transition across the page fold, and as discussed, the ad presentation module 120 presents the ad 780, here shown using the iframe tag. The ad 780 is animated and appears in this exemplary embodiment from the right-hand side of the web browser, however it could also appear in a similar manner from the left-hand side of the web browser and can appear at any position vertically within the web browser 700 and can be of any size and shape.

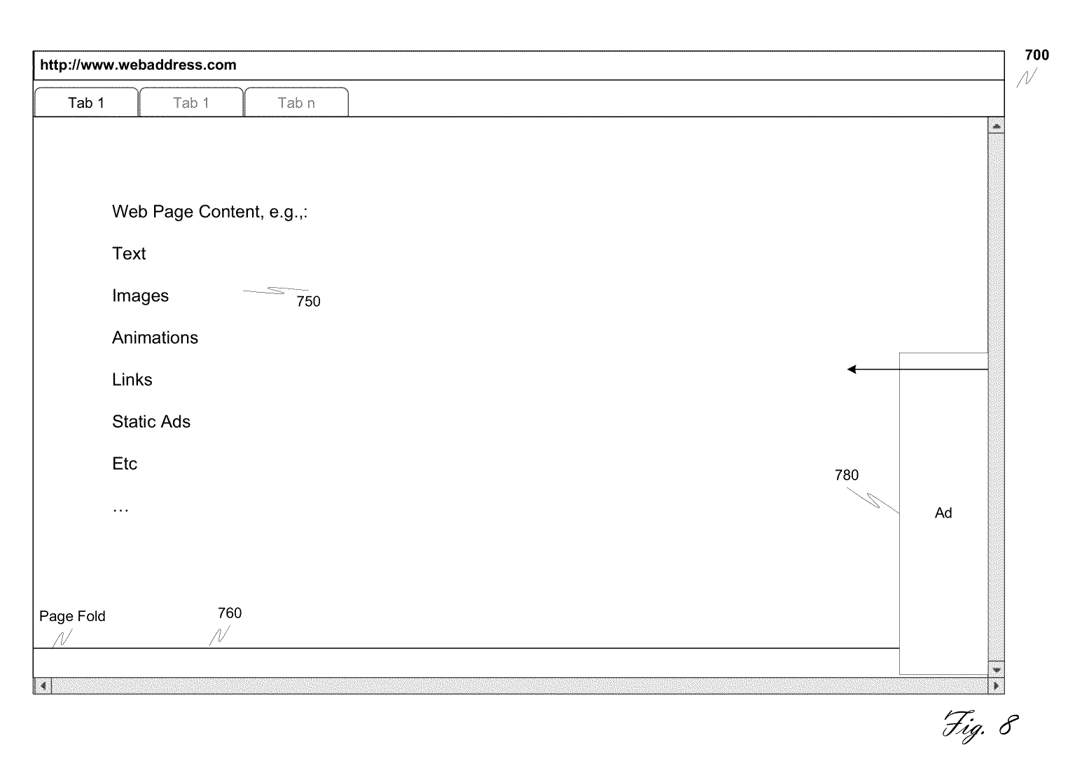

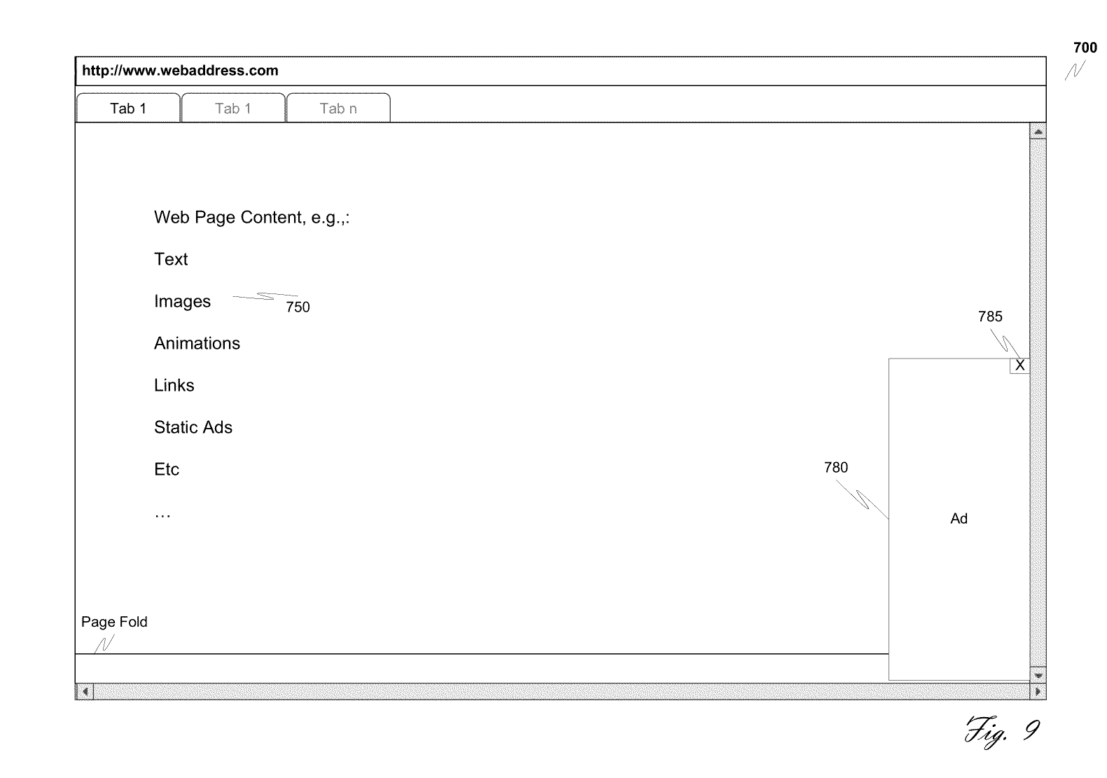

FIG. 8 shows a second frame in the animation where the ad 780 has appeared further out from the right-hand side and intermediate position, with FIG. 9 showing the ad 780 fully extended from the right-hand side of the web browser 700. As will be appreciated, there can be any type of content in the ad 780 including one or more of images, text, links, animations, videos, and in general any content that could be displayed in a browser-type environment. Optionally included with the ad 780 is a close button 785 that allows, for example, the user to close the ad. As discussed in accordance with an exemplary advantage of the techniques described herein, serving the ad in this manner increases the ratio of impressions to when the user actually sees the ad 780. As discussed, as the user is actively scrolling down the webpage 700, and the ad is served when the page fold is encountered, there is an extremely high likelihood that the ad will be seen by the user.

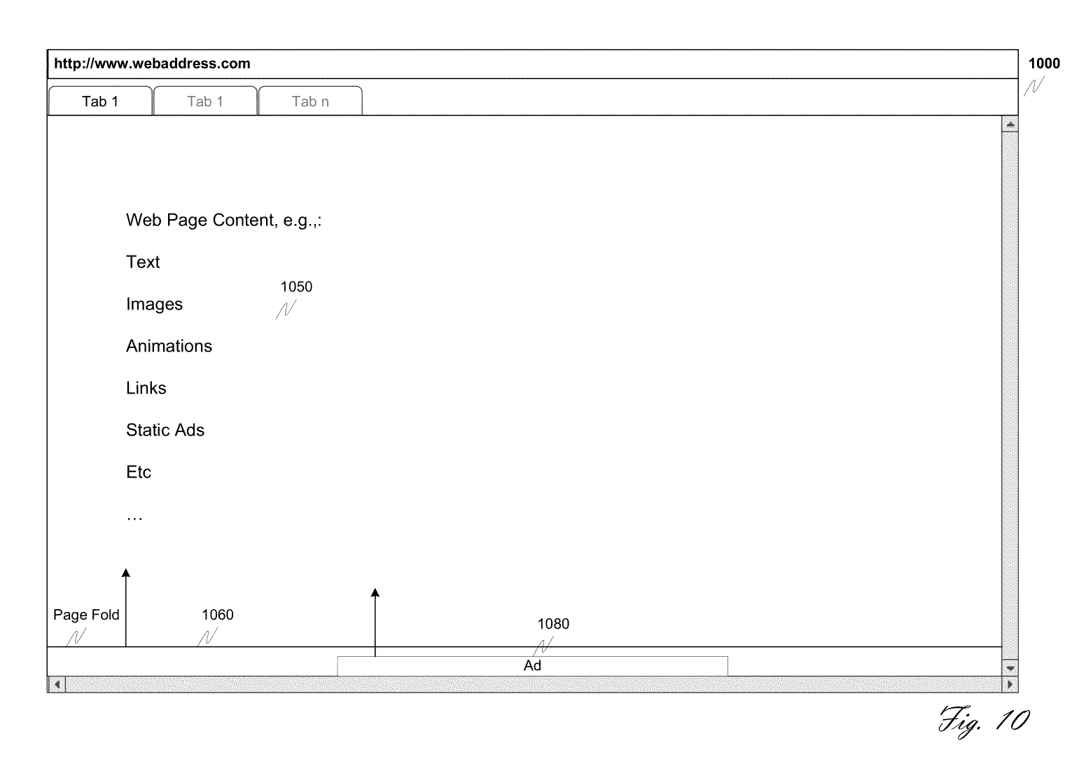

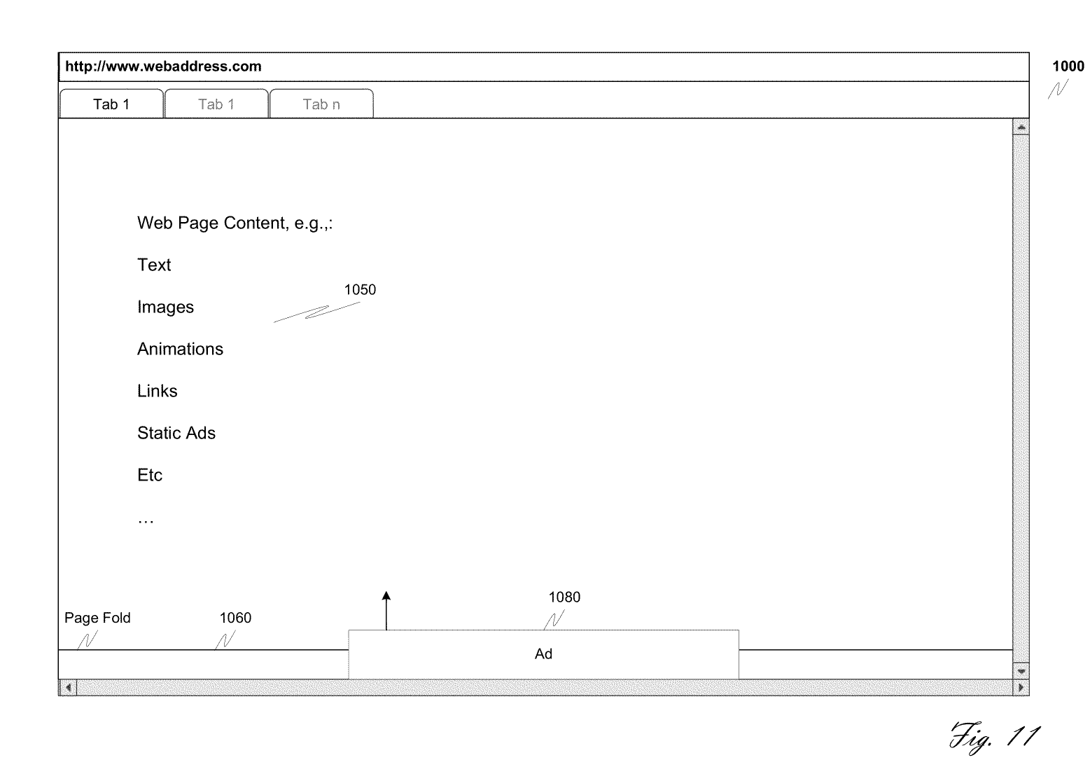

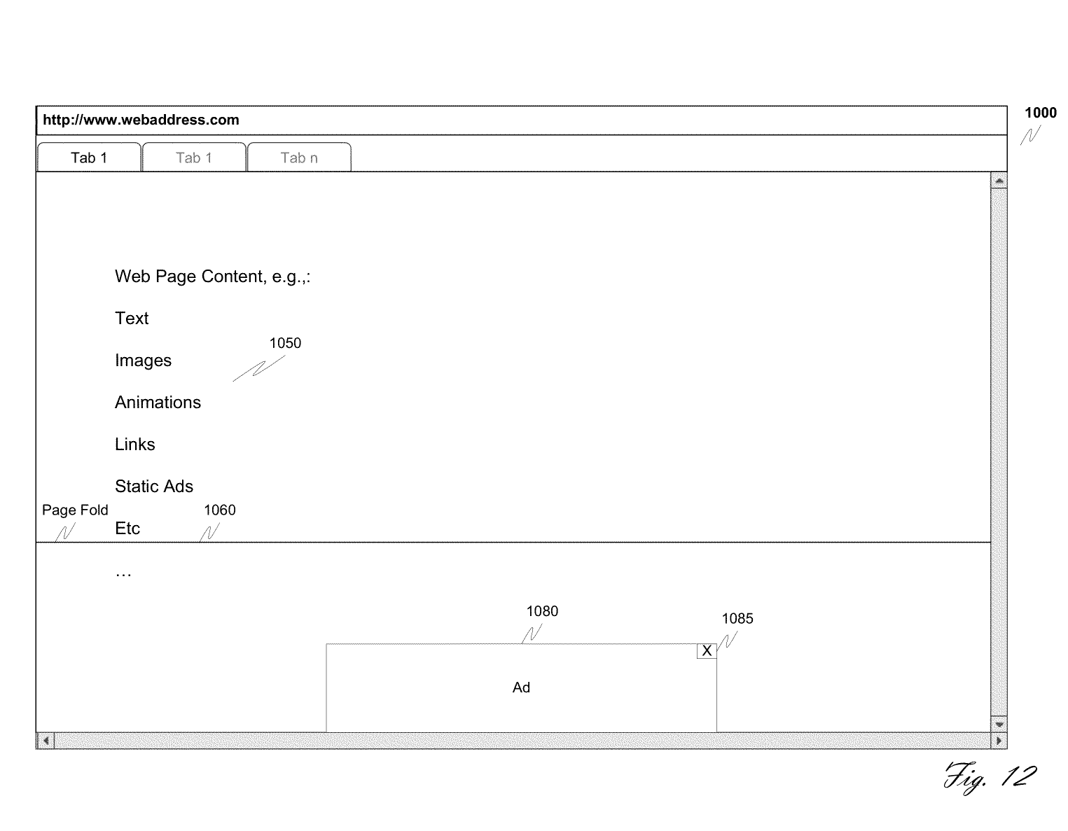

FIGS. 10-12 illustrate a second exemplary presentation of an ad where the ad is animated and appears from the bottom portion of the web browser 1000. As will be appreciated, the ad 1080 could also appear from the top portion of the browser 1000 and “drop down” into the viewable area of the browser 1000. Similar to the previous embodiment, when the user scrolls down the webpage 1000 to see additional web content 1050, a page fold is encountered which triggers the display of the ad 1080. In accordance with this exemplary embodiment, the ad 1080 “rises” from the bottom of the web browser 1000 from a first position in FIG. 10, to an intermediate position in FIG. 11, and a final position in FIG. 12, where the entirety of the ad 1080 is displayed. As with the previous embodiment, a close button 1085 can optionally be provided in the ad 1080 which can populated with any type of content, as discussed. In this exemplary embodiment, the user had used the scroll-wheel of the mouse to scroll down the webpage where a threshold had been set that the serving of the ad 1080 wouldn't incur until the page fold had traversed 30% (or other configurable value) of the viewable area of the web browser 1000. As, in accordance with this exemplary embodiment, 30% of the content “below the fold” was visible to the user before the ad 1080 was served.

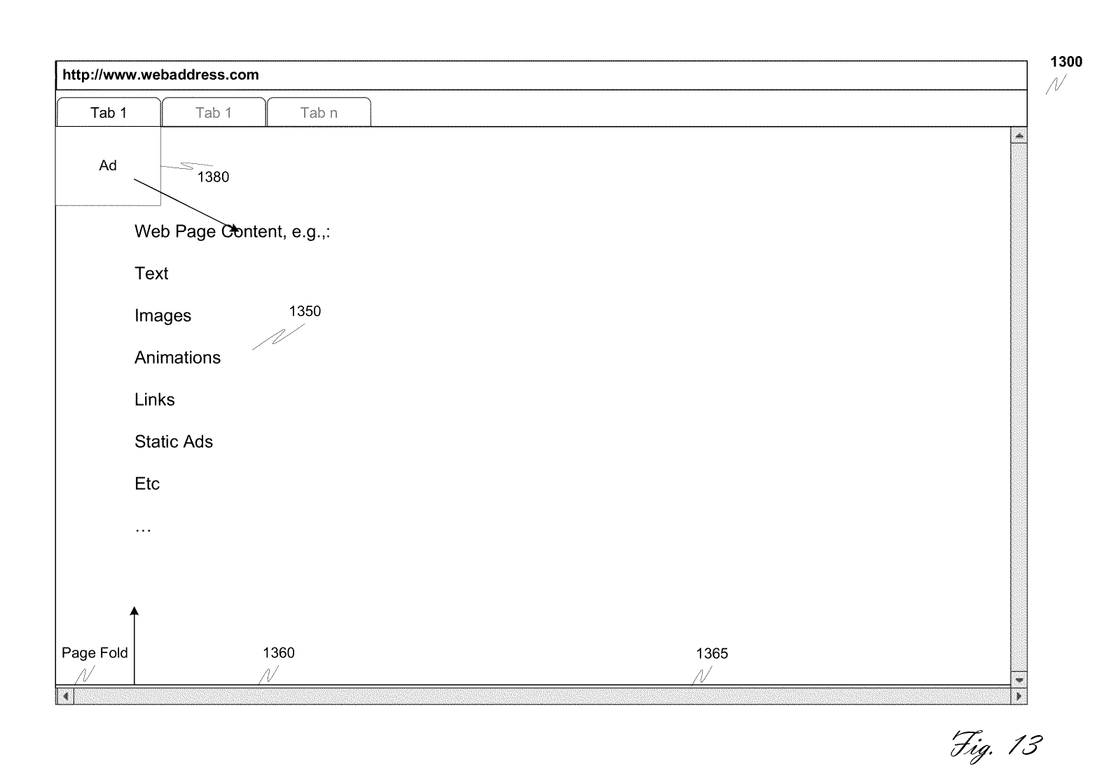

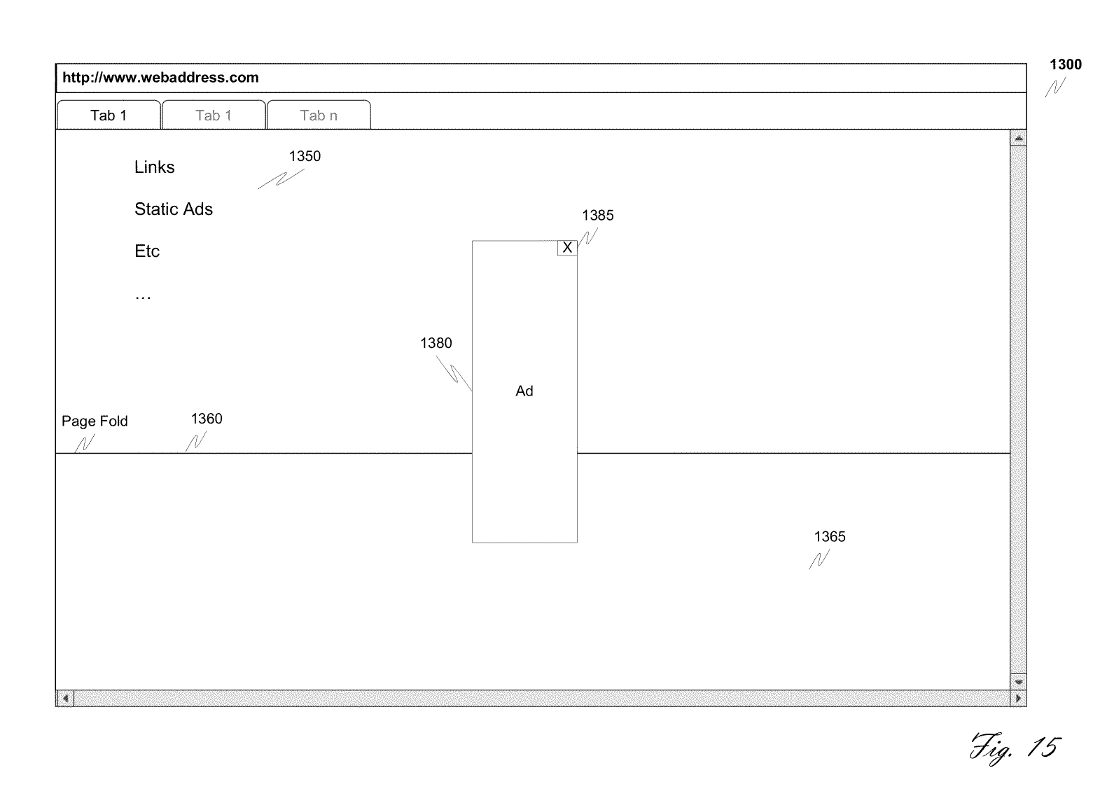

FIGS. 13-15 illustrate another exemplary embodiment where an ad is animated and appears from one corner of a web browser and floats above the webpage content to be finally displayed in the center of the browser. More specifically, FIG. 13 illustrates a web browser 1300 where a user has just barely invoked displaying of content below the page fold 1360 via, for example, use of a touchpad. The displaying of the below the fold content 1365, as detected by the scroll monitoring module 110, triggered displaying of ad 1380. In this exemplary embodiment, the ad 1380 begins appearing from the upper left-hand portion of the browser 1380 and floats above the webpage content 1350 until the entirety of the ad 1380 is shown in FIG. 15.

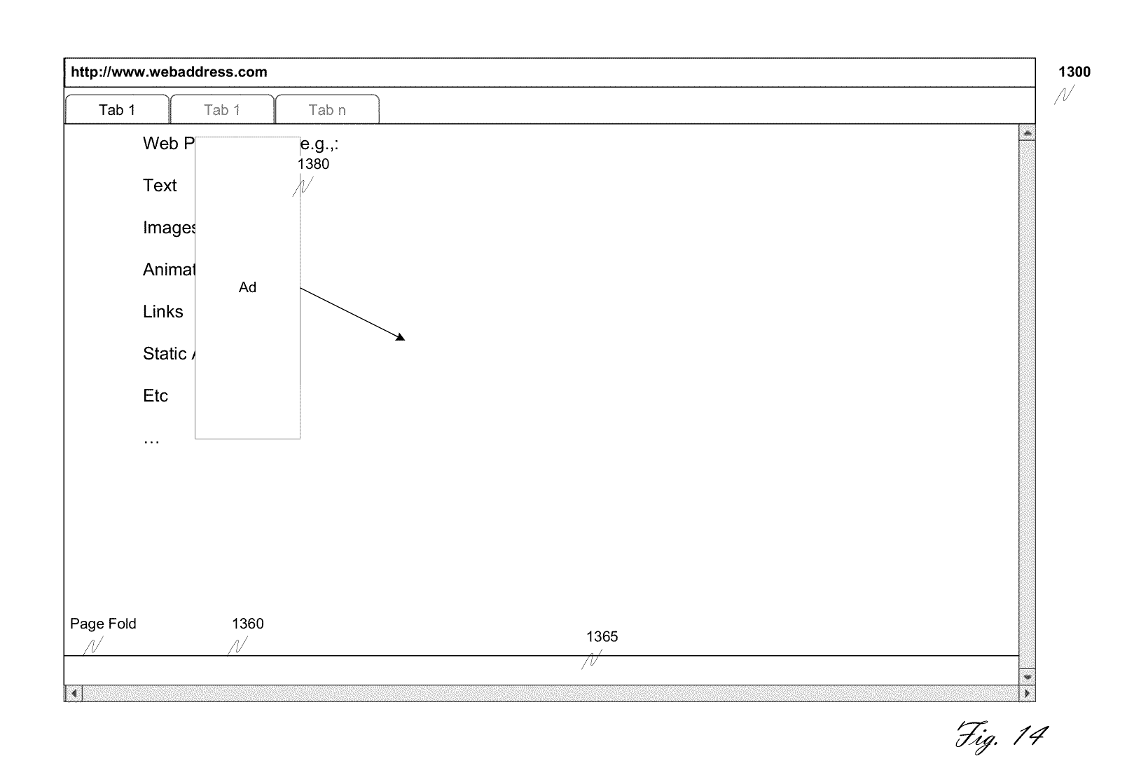

FIG. 14 illustrates an intermediate position of the ad 1380 as its animation continues to take it toward the center of the web browser 1300, within FIG. 14 illustrating that the page fold 1360 and content below the page fold 1365 continues to be more visible as the user is continuing the scroll action, as monitored by the scroll monitoring module 110. Therefore, in FIG. 15, content 1365 below the fold 1360 continues to be visible as the ad 1380 has completed its animation process and is fully visible in the center of the web browser 1300. As can be seen, the webpage content 1350 has shifted up the web browser 1300 with the content below the fold 1365 becoming visible. As with the other embodiments, an optional close button 1385 can be provided in conjunction with the ad 1380. If, for example, the user selects the close button 1385, the ad 1380 can transition off the web browser 1300 in a manner similar, but reverse, to the way it was presented, with it sliding back and off the upper-left hand corner of the browser 1300. Optionally, the ad 1380 can disappear immediately or transition off the screen by moving in some other direction, such as moving off the web browser 1300 by sliding off of the screen to the upper-right hand corner. The ad 1380 could also be associated with a timer, such that the ad disappears after a certain amount of time. Optionally further, the ad 1380 could disappear when the page fold 1360, for example, reaches the top of the browser window.

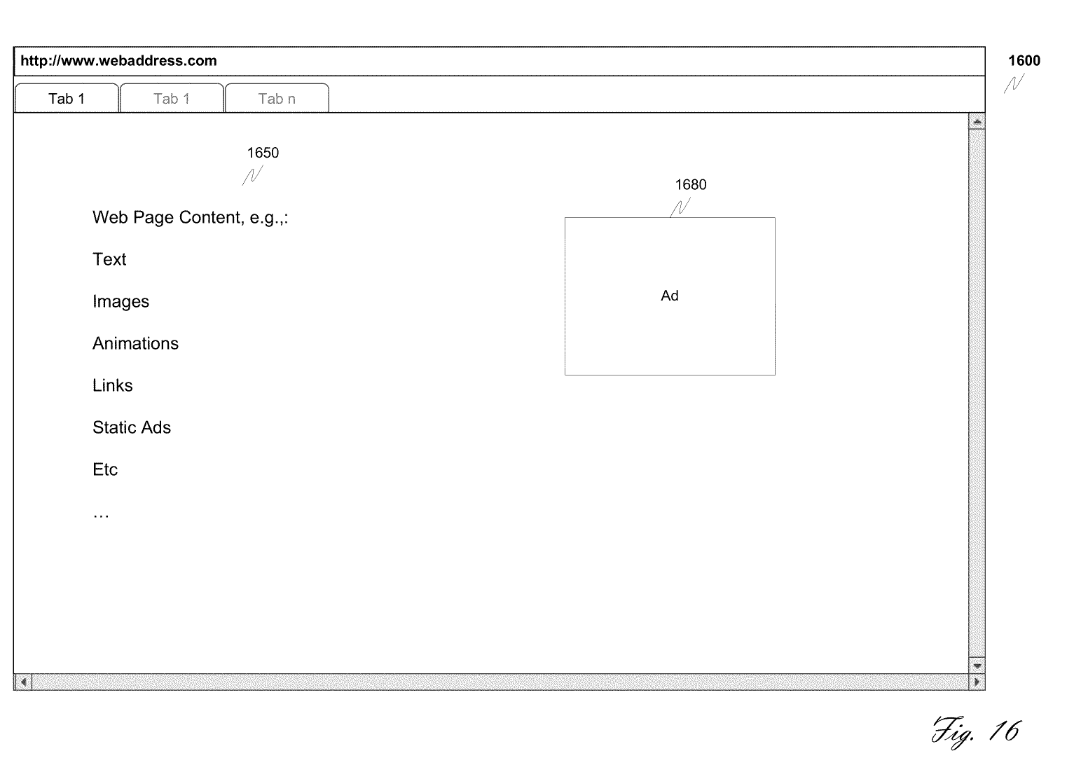

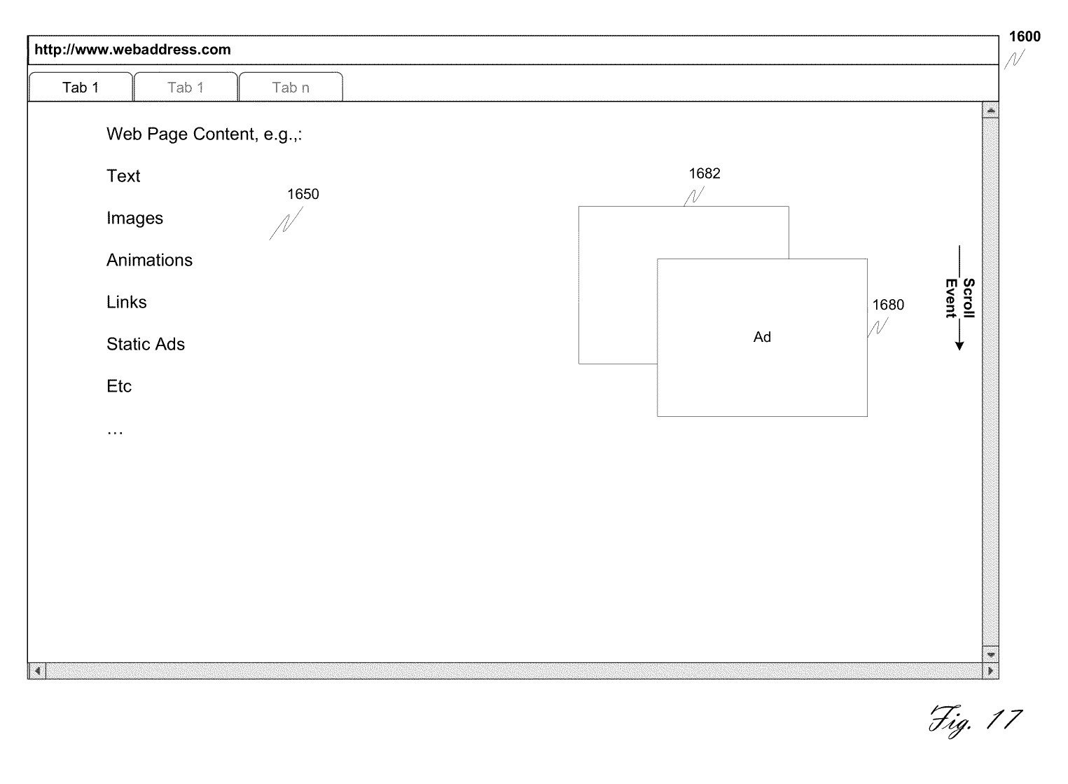

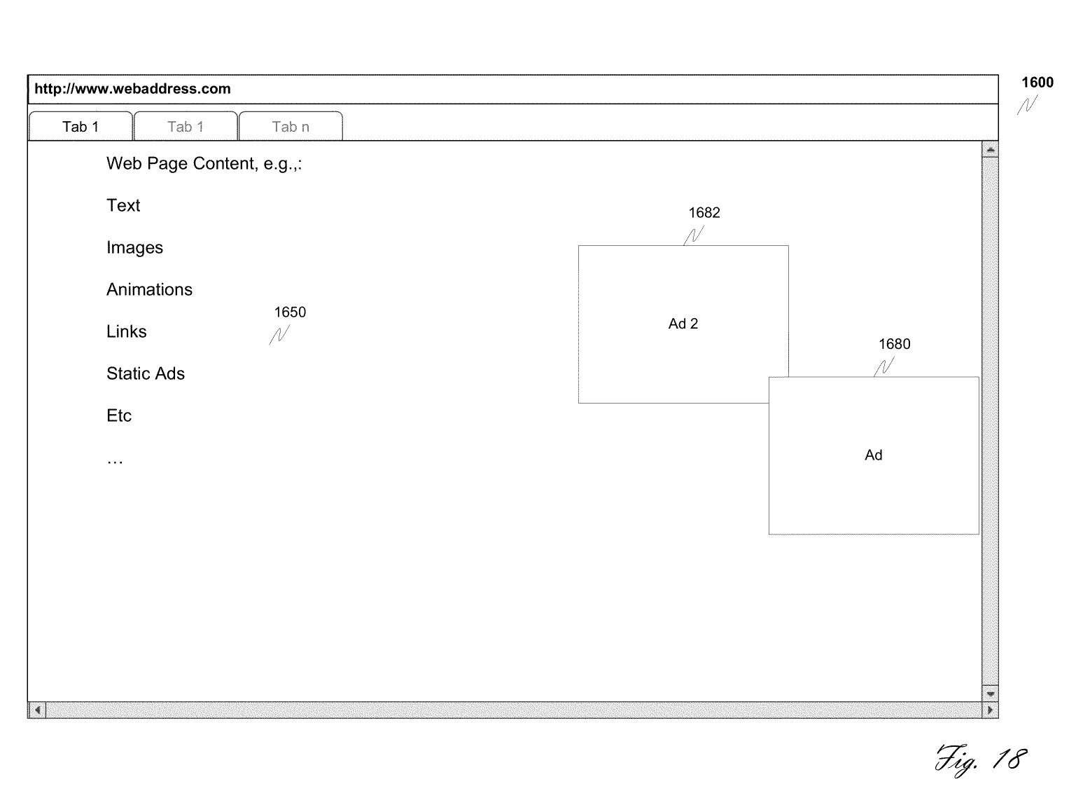

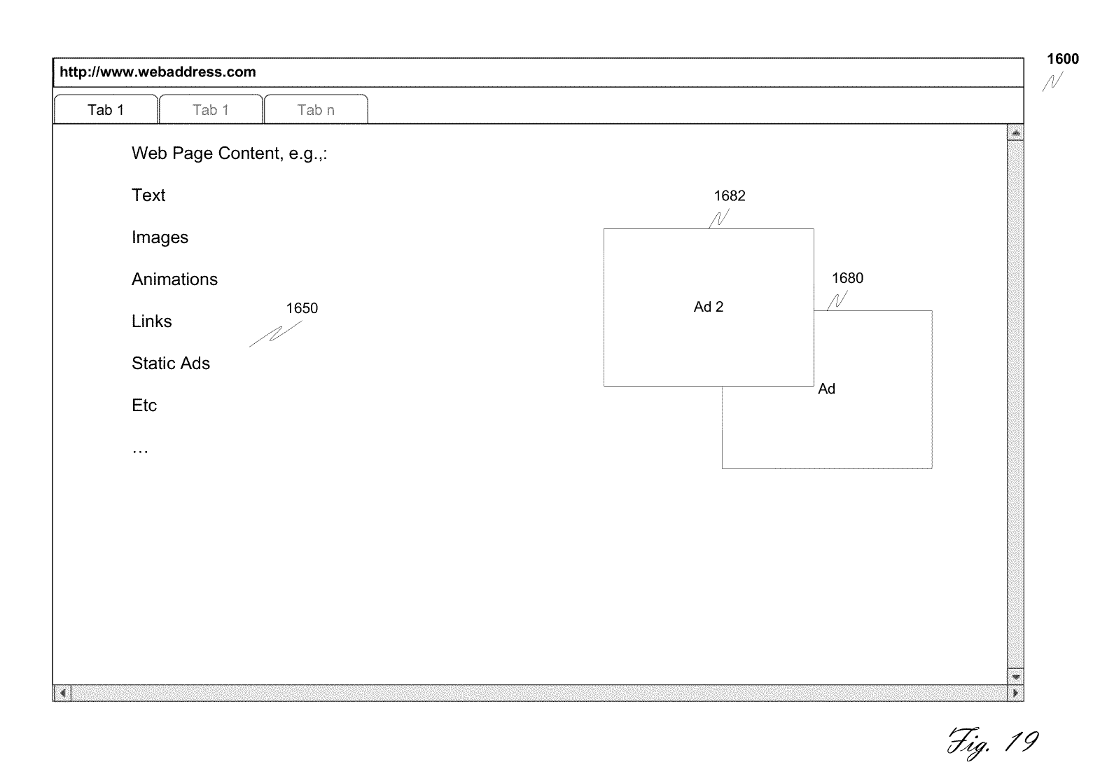

FIGS. 16-20 illustrate another exemplary method of displaying ads where the ad content is shuffled in a manner similar to a deck of cards. More specifically, FIG. 16 illustrates browser window 1600 that includes webpage content 1650 and an ad 1680. In FIG. 17, a scroll event has been detected which triggers the “shuffling” of the ad in a stack of cards. In FIG. 17, this shuffling is an animated process by which ad 1680 slides off the top of the “deck” to partially reveal a second ad 1682. In FIG. 18, the first ad 1680 has transitioned almost completely off of the top of the second ad 1682. With, in FIG. 19, the ad 1680 being placed at the “back” of the deck and ad 2 1682 becoming visible.

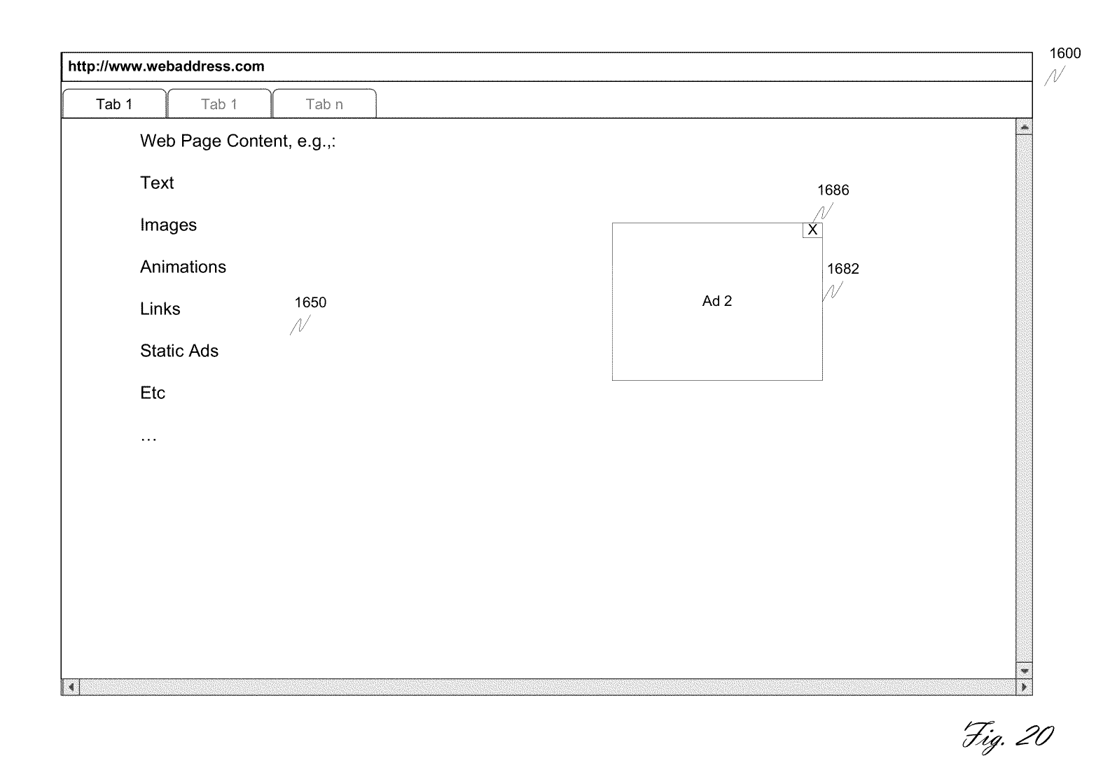

In FIG. 20, the ad 1680 is no longer visible and the ad 2 1682 is fully visible to the user within a browser window. As with the other embodiments, the close button 1686 can optionally be provided for this ad. While this exemplary embodiment has been illustrated in a relation to two ads 1680 and 1682, it should be appreciated that any number of ads can be in the stack and that the shuffling action be continuous in nature, or based, for example, on the detection of a further scroll event. Moreover, it should be appreciated that the ads not all be the same size, and they can be any size and position located anywhere within the browser window 1600. Moreover, the shuffling could be combined with any of the other embodiments discussed herein and can similarly include one or more of text, images, animations, video, or the like. Similarly, the speed at which the shuffling occurs can be dependent upon a variable, such as how fast the user is scrolling. Therefore, if the user is scrolling quickly, the shuffling action could also occur more quickly. Moreover, the ads in this embodiment could “float” above the webpage content 1650 such that as the user scrolls down the page, the ad stays in a static location relative to the webpage content being scrolled in the “background.” The ads could also appear in-line in a webpage, and could move as the surrounding content moves.

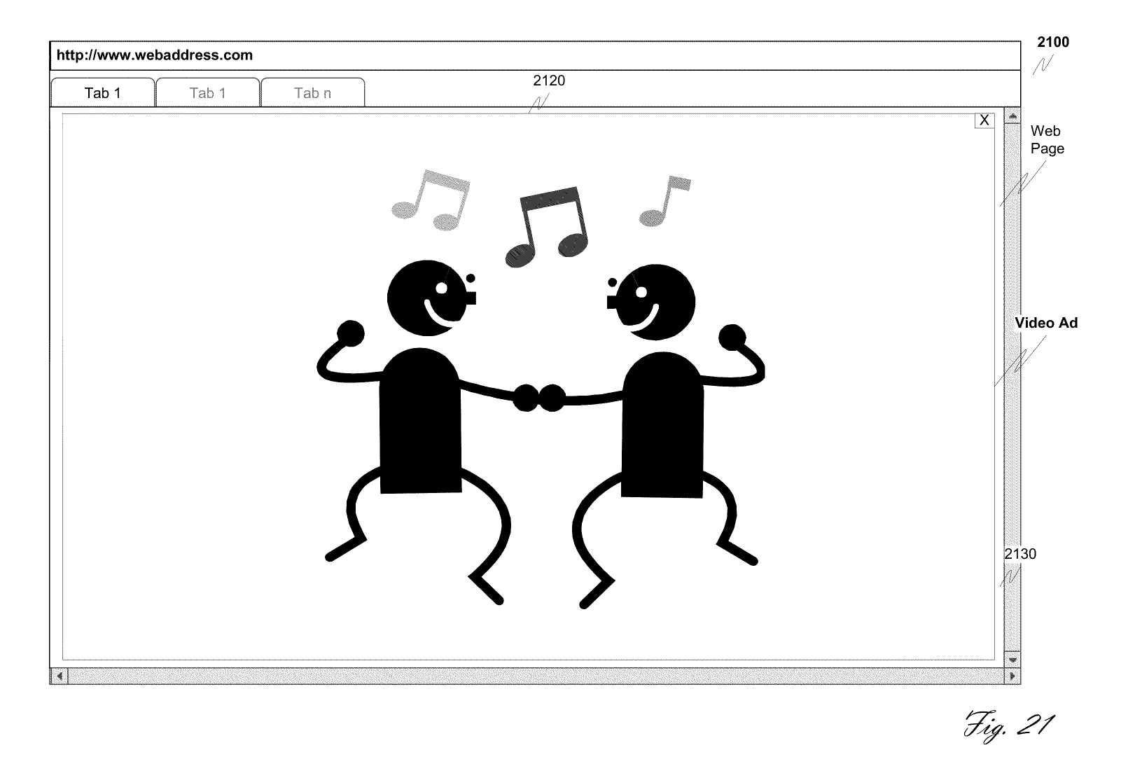

FIG. 21 illustrates another exemplary embodiment of displaying an ad or video content. Here, and similar to the other embodiments, an event is used as the trigger for the displaying of the ad or video, with the event being, for example, a scroll event and/or the detection of a page fold. Or, in general, this technique could be based on any event trigger and is not limited to scroll event detection or page fold detection as discussed herein. In accordance with this exemplary embodiment, upon the detection of event (e.g., a click event), a full screen, or nearly full screen, video window 2120 is presented in the browser 2100. Here, the video 2120 floats above the background webpage 2130. As with the other embodiments, a close button could be provided as well as optional controls such as play, pause, volume, and the like. In accordance with the embodiment illustrated in FIG. 21, while the video 2120 is shown as substantially filling the viewable area of the web browser, it is to be appreciated that the video 2120 could fill the entirety of the web browser or even be displayed in a full-screen mode taking up the entirety of the user's display.

In accordance with one exemplary embodiment, an ad, such as an InRead ad, is being displayed in the web browser. Upon the user hovering over the ad, the video 2120 that is associated with the ad is displayed in this full-screen, or near-full screen view displaying associated content. Upon the completion of this associated content being shown, the video 2120 could automatically be closed with additional shuffle-ads optionally being shown. This technique has an exemplary advantage in that a small portion or snippet of the video could be shown in a smaller window, and upon a triggering event, the video automatically be resized to fill all or substantially all of either the user's browser 2100 or display (not shown).

In accordance with another exemplary implementation, and applicable to any of the embodiments disclosed herein, if there is audio associated with an ad, the audio may not be played or heard until the user hovers over the ad, which would cause the audio to be un-muted or played. Then when the user is no longer hovering over the ad, the audio could then again be muted or paused. This may or may not have an effect on the playing of the underlying video/animation. For example, a video could begin playing, in a muted mode until the user hovers over the ad and the audio is audible. When the user is detected as no longer hovering over the ad, the audio could be muted but the video may continue to play. Optionally still, a click event could cause the ad to transition to a full-screen or substantially full-screen mode. Optionally still, if the ad is a video ad or animation, the video/animation may not be played until a portion of the ad comes into view in the browser window. The video/animation could then be paused if a certain portion of the video/animation transitions out-of-view. Similarly, if a portion of the ad comes back into view, the video/animation could continue playback. These portions could be based on, for example, a specified percentage of the ad coming into or transitioning out of view. Upon completion of the video/animation, the ad could “shrink” with the surrounding content, such as text, being moved into the location where the ad was displayed. In accordance with another optional embodiment, a click event or a hover event may trigger the browser to be re-directed to another, such as the advertiser's, website.

As with the other embodiments, displaying of the video window 2120 can be combined with any of the other embodiments discussed herein and, for example, slide-in from the bottom-right corner of the web browser 2100 or display until it is in a full or substantially full-screen mode.

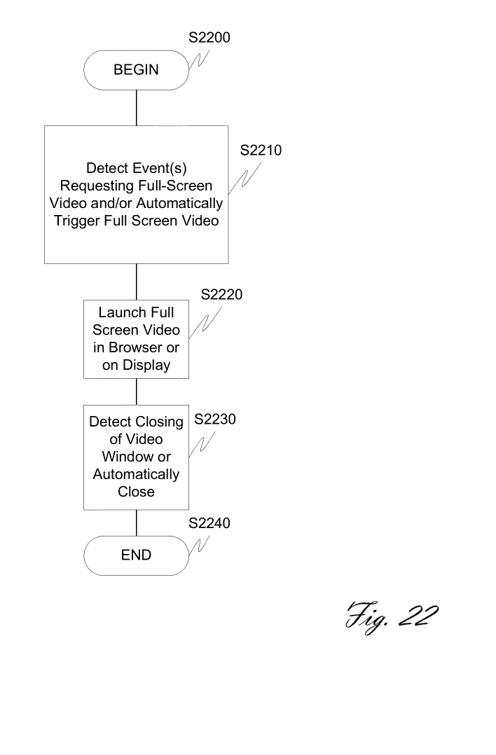

FIG. 22 illustrates an exemplary method for monitoring a web page for a scroll event. In particular, control begins in step S210 and continues to step S220. In step S220, input to the web page is monitored. Next, in step S230, a scroll event for the web page is detected. As discussed, this scroll event can originate from one or more of a mouse, touch pad, touch screen, track point button, cursor, or the like. Then, in step S240, the detected scroll event is used for initiating one or more actions. Control then continues to step S250 where the one or more actions are triggered with control continuing to step S260 where the control sequence ends.

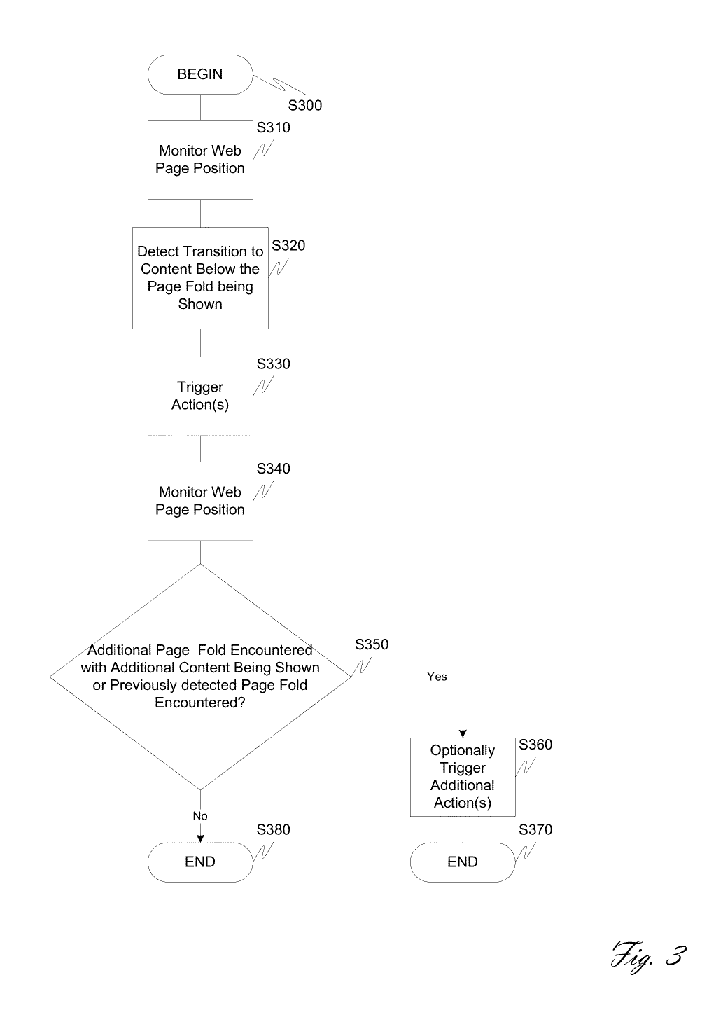

FIG. 3 outlines an exemplary method for monitoring a page fold. In particular, control begins in step S300 and continues to step S310. In step S310, the position of the web page is monitored. Next, in step S320, transition across a page fold is detected. For example, a page fold can be detected where content below the page fold is being displayed, or alternatively, a page fold can be detected where content above the page fold is being shown. Then, in step S330, and based on this detection, one or more actions can be triggered. As discussed, the detection step in S320 can be associated with one or more thresholds, such as page fold position, amount of content above or below the fold being shown, and/or percentage or number of pixels above or below a fold being shown.

In step S340, the web page position can optionally be continued to be monitored, with in step S350 the determination being made as to whether additional page folds are encountered with additional content being shown or alternatively whether a previously detected page fold is again being displayed. If none of these conditions are satisfied, control jumps to step S380 where the control sequence ends. Otherwise, control continues to step S360 where additional triggers can optionally be used to initiate one or more additional actions, with control continuing to step S370 where the control sequence ends.

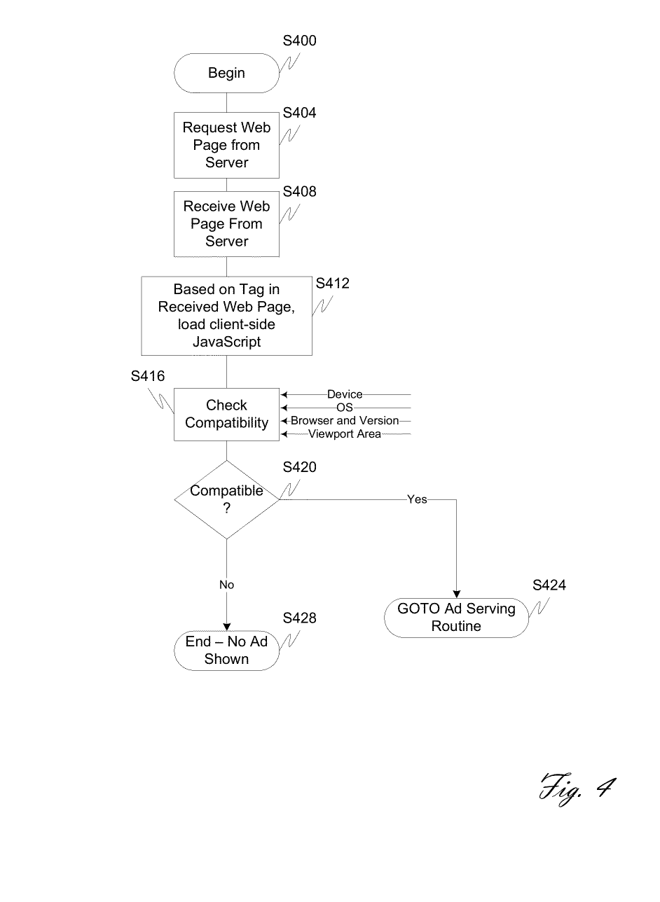

FIG. 4-FIG. 6 illustrate an exemplary technique for displaying an ad. In particular, control begins in step S400 and continues to step S404. In step S404, a web page is requested from a server. Next, in step S408, the requested web page is received at a client computer from the web server. Then, in step S412, and based on a tag in the received web page, a client-side JavaScript is loaded. Control then continues to step S416.

In step S416, a compatibility check is performed that includes one or more of device compatibility, operating system compatibility, browser and version compatibility, and viewport area compatibility. Next, in step S420, a determination is made as to whether the client computer is compatible. If the client computer is not compatible, control continues to step S428 where the control sequence ends. Otherwise, control continues to step S424 where the ad serving routine is run.

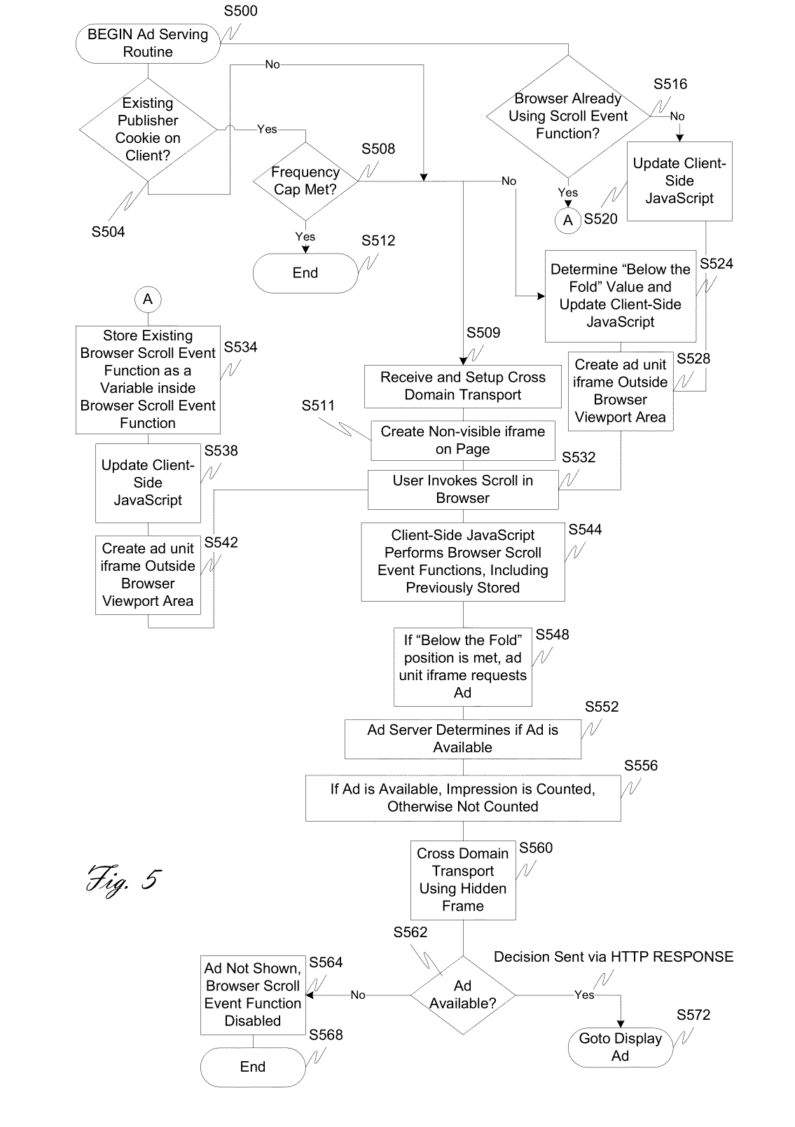

FIG. 5 illustrates an exemplary embodiment for the ad serving routine S500 that could be used with, for example, the sliding ad technologies discussed herein. In particular, control begins in step S500 and continues to steps S504 and S516. In step S504, the determination is made as to whether an existing publisher cookie is present on the client computer. If a cookie is present, control continues to step S508 with control otherwise jumping to steps S524 and S509.

In step S508, a determination is made as to whether a frequency cap with a number of instances an ad has been shown has been met. If the frequency cap has been met, control continues to step S512 where the control sequence ends. Otherwise, control continues to steps S524 and S509.

In step S516, a determination is made as to whether browser is already running or using a scroll event function that determines whether the user has requested scrolling of the web page. If the scroll event function is already running on the client computer, control jumps to step S534, with control otherwise continuing to step S520. In step S520, the client-side JavaScript is updated with control continuing to step S528.

In step S528, an ad unit iframe is created inside or outside the browser viewport area with control continuing to step S532.

In step S524, a determination is made as to whether a below the fold value has been encountered, and the client-side JavaScript updated accordingly, with control continuing to step S528.

In step S509, a cross-domain transport is received and set up. Then, in step S511, a non-visible iframe is created on the web page.

In step S534, an existing browser scroll event function is stored as a variable inside the browser scroll event function. In step S538 the client-side JavaScript is updated with, in step S522, an ad unit iframe being created outside the browser viewport area. Control then continues to step S532.

In step S532, the user invokes a scroll in the browser which is detectable. In step S544, the client-side JavaScript performs a browser scroll event function initiation including reading any previously stored values. Then, in step S548, if a below the fold position is met, an ad unit iframe requests an ad from, for example, an ad server. As will be appreciated, while this exemplary embodiment is discussed in relation to a below the fold detection, it can also be used for detecting multiple below the fold transitions as well as one or more above the fold transitions. Control then continues to step S552.

In step S552 the ad server determines whether the ad is available. In step S556, if the ad is available, an impression is counted. Then, in step S560, this information can be sent using a cross-domain transport and a hidden frame to the client computer. Control then continues to step S562. In step S562 a determination is made as to whether the ad is available. If the ad is not available, no ad is shown in step S564 and the browser's scroll event function can be disabled. Control then continues to step S568 where the control sequence ends.

If, however, an ad is available, control continues to step S552, with information regarding the availability of the ad being optionally sent via an HTTP response.

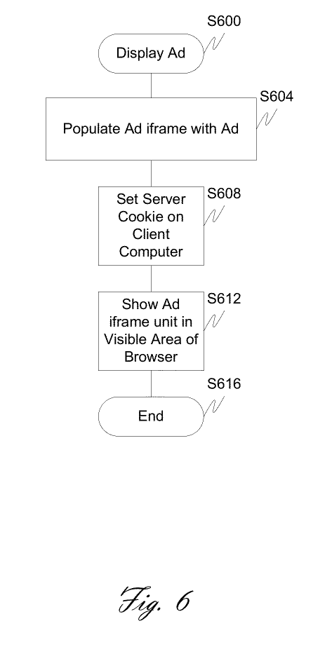

FIG. 6 outlines an exemplary method for the displaying of an ad. In particularly, control begins in step S600 and continues to step S604. In step S604, an ad iframe is populated with an ad. Next, in step S608, a cookie can optionally be set on the client computer by the ad server. Then, in step S612, the ad iframe unit can be shown in the visible area of the browser, in conjunction with the associated ad. Control then continues to step S616 where the control sequence ends.

As discussed, any of the techniques described above can be used in conjunction with any one or more of the ad display techniques discussed in relation to FIG. 7-FIG. 21. It will be appreciated that one or more of these techniques could be combined and intermixed depending on, for example, publisher preferences.

FIG. 22 outlines an exemplary method for triggering and displaying full-screen video content. In particular, control begins in step S2200 and continues to step S2210. In step S2210, one or more events are detected either requesting a full-screen video or it automatically triggers a full-screen video. For example, upon a user hovering over a particular advertisement, this hovering activity can be a triggering event that causes the launching of a full-screen video. As discussed, this full-screen video can be launched in all, or substantially all, of the browser window, the full-screen in a user's display and/or can be launched in a media player. As will be appreciated, the event could also be a scrolling or page-fold detection event as discussed herein.

Next, in step S2220, the full-screen video is launched in, for example, the web browser or on the user's display. Then, in step S2230, one or more of the video can be automatically closed, for example, when the video is finished playing, the user can close the video window, the video window can automatically close if, for example, another event is detected, such as a further page scroll, a change in focus, or the like. Similarly, control of the playback of the video can also be controlled based on the detection of one or more of these events such that, for example, if there is a change in focus, the video is automatically paused. Control then continues to step S2240 where the control sequence ends.

The exemplary systems and methods of this disclosure have been described in relation to an advertising system and techniques as well as triggering event(s). However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein discuss the various components of the system collocated, certain components of the system can be located remotely, at distant portions of a distributed network, such as a LAN and/or the Internet, or within a dedicated system and/or within a cloud computing environment. Thus, it should be appreciated, that the components of the system can be combined in to one or more devices, such as a computer, computing device and/or server(s), or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

```
APPENDIX
Device and Browser Detection:
      function zd_get_browser_size_position( ) {
            var zd_sAgt = navigator.userAgent;
            var ix = 0;
            var zd_sFullVersion = “ + parseFloat(navigator.appVersion);
            if (navigator.userAgent.toLowerCase( ).indexOf(‘chrome’) > −1) {
                  zd_nBrowserType = 1;
            }
            else if (navigator.userAgent.indexOf(‘Netscape’) > −1 ||
navigator.userAgent.indexOf(‘Firefox’) > −1) {
                  zd_nBrowserType = 3;
            }
            else if (navigator.userAgent.indexOf(‘Opera’) > −1) {
                  zd_nBrowserType = 4;
            }
            if (navigator.appVersion.indexOf(‘Mac’)> −1) {
                  zd_nOSType = 1;
                  if (navigator.platform == ‘iPad’) {
                        zd_nDevice = 1;
                  }
                  else if (navigator.platform.indexOf(‘iPhone’) > −1) {
                        zd_nDevice = 2;
                  }
                  else if (navigator.platform == ‘iPod’) {
                        nDevice = 3;
                  }
            }
            if ( !zd_nBrowserType && (verOffset = zd_sAgt.indexOf(‘MSIE’)) > −1){
                  zd_nBrowserType = 2;
                  zd_sFullVersion = zd_sAgt.substring(verOffset + 5);
                  if (zd_doctype == “CSS1Compat”) {
                        zd_bIsIECompatMode = true;
                  }
            }
            if ((ix = zd_sFullVersion.indexOf(“;”)) != −1)
                  zd_sFullVersion = zd_sFullVersion.substring(0, ix);
            if ((ix = zd_sFullVersion.indexOf(“ ”)) != −1)
                  zd_sFullVersion = zd_sFullVersion.substring(0, ix);
            zd_nMajorVersion = parseInt(“ + zd_sFullVersion, 10);
            if (isNaN(zd_nMajorVersion)) {
                  zd_sFullVersion = ” + parseFloat(navigator.appVersion);
                  zd_nMajorVersion = parseInt(navigator.appVersion, 10);
            }
            zd_get_viewport_dimensions( );
      }
Browser Width and height Detection Code:
function zd_get_viewport_dimensions( ){
            if (zd_nBrowserType == 1) {
                  zd_nPagesize = document.body.scrollHeight;
            } else if (zd_nBrowserType == 3) {
      if(document.documentElement.offsetHeight>document.body.scrollHeight){
                        zd_nPagesize = document.documentElement.offsetHeight;
                  }
                  else{
                        zd_nPagesize = document.body.scrollHeight;
                  }
            }
            else {
                  zd_nPagesize = document.body.scrollHeight;
            }
            if (typeof window.innerWidth != ‘undefined’)
            {
                  zd_nViewportWidth = window.innerWidth;
                  zd_nViewportHeight = window.innerHeight;
            }
            else if (typeof document.documentElement != ‘undefined’
                  && typeof document.documentElement.clientWidth !=
                        ‘undefined’ && document.documentElement.clientWidth
!= 0)
            {
                  zd_nViewportWidth = document.documentElement.clientWidth;
                  zd_nViewportHeight = document.documentElement.clientHeight;
            }
            else
            {
                  zd_nViewportWidth =
document.getElementsByTagName(‘body’)[0].clientWidth;
                  zd_nViewportHeight =
document.getElementsByTagName(‘body’)[0].clientHeight;
            }
            if((typeof zflag_visible_position!=“undefined”) &&
(!isNaN(zflag_visible_position)) && (zflag_visible_position>0)){
                  zd_nTriggerHeight=zflag_visible_position;
            }
            else{
                  if(zd_nPagesize>(zd_nViewportHeight*2)){
                        zd_nTriggerHeight = zd_nViewportHeight;
                  }
            }
      }
Reload Iframe Code:
function zd_get_ad( ) {
      if (!zd_bOnceLoadIframe) {
            zd_check_keyword( );
            if(typeof zflag_kw != “undefined”){
            document.getElementById(‘zzmainframe’).src =
“+zedo_locationdomain+‘jsc/’+zedo_subdomain+‘ff2.html?n=’+zflag_nid+
‘;c=’+zflag_cid+‘;s=’+zflag_sid+‘;d=’+zflag_sz+‘;w=’+zflag_width+‘;h=’+zflag_height+‘;
q=’+zflag_kw;
            }
            else if(typeof zflag_refkw !=“undefined”){
            document.getElementById(‘zzmainframe’).src =
“+zedo_locationdomain+‘jsc/’+zedo_subdomain+‘ff2.html?n=’+zflag_nid+
‘;c=’+zflag_cid+‘;s=’+zflag_sid+‘;d=’+zflag_sz+‘;w=’+zflag_width+‘;h=’+zflag_height+‘;
q=’+zflag_refkw;
            }
            else{
            document.getElementById(‘zzmainframe’).src =
“+zedo_locationdomain+‘jsc/’+zedo_subdomain+‘ff2.html?n=’+zflag_nid+
‘;c=’+zflag_cid+‘;s=’+zflag_sid+‘;d=’+zflag_sz+‘;w=’+zflag_width+‘;h=’+zflag_height;
            }
            var zd_socket = new easyXDM.Socket({
            remote: “”+zedo_locationdomain+“utils/socket.html”,
            swf: “”+zedo_locationdomain+“utils/fhstrans.swf”,
            onMessage: function(message, origin){
            if(message==“zedoad”) {
                  zd_bHaveAd = true;
                  zedo_nMode = 1;
                  zd_nCookieValue++;
      zd_set_cookie(“ZEDOHSLIDER”+zflag_cid+zflag_sid,zd_nCookieValue);
                  zd_expand_ad( );
                  if(typeof zflag_loading_indicator==“undefined”){
                  setTimeout(zd_loading_indicator_hide,2000);
                  }
                  }
            },
            onReady: function( ) {
            zd_socket.postMessage(“hello”);
            }
            });
            zd_bOnceLoadIframe = 1;
      }
      if(typeof zflag_loading_indicator==“undefined”){
      var zd_ad_show_wrapper = document.getElementById(‘zzad’);
      zd_ad_show_wrapper.style.backgroundImage =
“url(‘“+zedo_locationdomain+”horizontalsliders/images/ajax-loader.gif’)”;
      zd_ad_show_wrapper.style.backgroundRepeat = “no-repeat”;
      zd_ad_show_wrapper.style.backgroundPosition = “center”;
      }
      if (zedo_nMode == 1) {
      return 0;
      }
}
Open Ad Code:
function zd_open_ad( )
      {
            var zd_nObj = document.getElementById(‘zzsliderlayer_box’);
            if (zedo_nMode != 1) {
                  return 0;
            }
            if(zd_sSliderposition==“right”){
                  if (zd_nObj.style.right < “0px”) {
                        if((typeof
zflag_no_slide!=“undefined”)&&(zflag_no_slide)){
                              zd_nRight = 0;
                              zd_nObj.style.right = zd_nRight + “px”;
                              setTimcout(zd_open_ad, zd_nCreativeWidth);
                        }
                        else{
                              timer = 20;
                              zd_nRight += 5;
                              zd_nObj.style.right = zd_nRight + “px”;
                              setTimeout(zd_open_ad, 20);
                        }
                  }
                  else {
                        zd_nRight = 0;
                  }
            }
            else if(zd_sSliderposition==“left”){
                  if (zd_nObj.style.left < “0px”) {
                        if((typeof
zflag_no_slide!=“undefined”)&&(zflag_no_slide)){
                              zd_nRight = 0;
                              zd_nObj.style.left = zd_nRight + “px”;
                              setTimeout(zd_open_ad, zd_nCreativeWidth);
                        }
                        else{
                              timer = 20;
                              zd_nRight += 5;
                              zd_nObj.style.left = zd_nRight + “px”;
                              setTimeout(zd_open_ad, 20);
                        }
                  }
                  else {
                        zd_nRight = 0;
                  }
            }
      }
Close Ad Code:
function zd_close_ad( )
      {
            if (zedo_nMode != 2) {
                  return 0;
            }
            var zd_nObj = document.getElementById(‘zzsliderlayer_box’);
            if (zd_nRight > −(zd_nCreativeWidth)) {
                  if (zd_nBrowserType == 2) {
                        if((typeof
zflag_no_slide!=“undefined”)&&(zflag_no_slide)){
                              zd_nRight = −zd_nCreativeWidth;
                        }
                        else{
                              zd_nRight −=20;
                              timer = 1;
                        }
                  }
                  else {
                        if((typeof
zflag_no_slide!=“undefined”)&&(zflag_no_slide)){
                              zd_nRight = −zd_nCreativeWidth;
                        }
                        else{
                              zd_nRight −=5;
                        }
                  }
                  if(zd_sSliderposition==“right”){
                        zd_nObj.style.right = zd_nRight + “px”;
                        if((typeof
zflag_no_slide!=“undefined”)&&(zflag_no_slide)){
                              setTimeout(zd_close_ad, zd_nCreativeWidth);
                        }
                        else{
                              setTimeout(zd_close_ad, 20);
                        }
                  }
                  if(zd_sSliderposition==“left”){
                        zd_nObj.style.left = zd_nRight + “px”;
                        if((typeof
zflag_no_slide!=“undefined”)&&(zflag_no_slide)){
                              setTimeout(zd_close_ad, zd_nCreativeWidth);
                        }
                        else{
                              setTimeout(zd_close_ad, 20);
                        }
                  }
            }
            else {
                  if (zedo_bUIC){
                        document.getElementById(‘zzopenclosediv’).style.display
=‘block’;
                        zd_change_opencloseelement( );
                  }
                  zd_nObj.style.height=“106px”;
                  zd_nObj.style.width=“26px”;
                  if(zd_sSliderposition==“right”){
                        zd_nObj.style.right =“0px”;
                  }
                  else if(zd_sSliderposition==“left”){
                        zd_nObj.style.left =“0px”;
                  }
                  zd_nObj.style.visibility = ‘hidden’;
            }
      }
Change Ad Load Position Code:
function zd_change_opencloseelement( ){
      var zd_sOpenCloseTab = document.getElementById(‘zzopenclosediv’);
      if(zd_sSliderposition==“right”){
            zd_sOpenCloseTab.style.right=“0px”;
            zd_sOpenCloseTab.style.float=“right”;
      }
      else if(zd_sSliderposition==“left”){
      zd_sOpenCloseTab.className=“zzopenclosedivleft”;
      zd_sOpenCloseTab.style.left=“0px”;
      zd_sOpenCloseTab.style.float=“left”;
      }
}
Scroll Event Code:
if(zd_nDevice == 1) {
window.onscroll = zd_ios_scroll;
}
else {
window.onscroll = zd_show_ad;
}
Set Cookie Code
function zd_set_cookie(cookie_name, cookie_val) {
document.cookie=cookie_name+“=” +cookie_val +“;expires=”+ zd_getCookieLife( ) +
“;domain=”+document.domain+“;path=/”;
}
```

1. A computing-device based system comprising:
a scroll monitoring module adapted to monitor a web page position in a web browser and to detect a scroll event in the web browser;
a page fold detection module adapted to detect a page fold in the web browser; and
a processor adapted to trigger one or more actions based one or more of the detections.

2. The system of claim 1, further comprising a process and function recording module adapted to evaluate one or more of device compatibility, operating system compatibility, browser compatibility, version compatibility and viewport area.

3. The system of claim 1, further comprising an ad presentation module adapted to display one or more ads as a result of the triggering step.

4. The system of claim 3, wherein the one or more ads are presented using an iframe after a below the fold value is determined.

5. The system of claim 4, wherein the below the fold value is based on a percentage of content displayed or a number of pixels.

6. The system of claim 4, further comprising an impression recording module adapted to count an impression when the one or more ads are served.

7. The system of claim 3, wherein the one or more ads are shown in an iframe unit in a visible area of the web browser and the presentation of the iframe is animated.

8. The system of claim 1, wherein the monitoring, detecting and triggering are performed on a computer, a smart TV, a mobile device or a computing device.

9. The system of claim 1, wherein a non-visible iframe is created by an ad presentation module and the one or more actions include showing a video in a full-screen or substantially full-screen mode in either the web browser or on a display.

10. A method comprising:
monitoring, by a processor, a web page position in a web browser;
detecting one or more of a scroll event in the web browser and a page fold in the web browser; and
triggering one or more actions based on the detecting.

11. The method of claim 10, further comprising evaluating one or more of device compatibility, operating system compatibility, browser compatibility, version compatibility and viewport area.

12. The method of claim 10, further comprising displaying one or more ads as a result of the triggering step.

13. The method of claim 12, wherein the one or more ads are presented using an iframe after a below the fold value is determined.

14. The method of claim 13, wherein the below the fold value is based on a percentage of content displayed or a number of pixels.

15. The method of claim 12, further comprising counting an impression when the one or more ads are served.

16. The method of claim 12, wherein the one or more ads are shown in an iframe unit in a visible area of the web browser and the iframe is animated.

17. The method of claim 10, wherein the monitoring, detecting and triggering are performed on a computer, a smart TV, a mobile device or a computing device.

18. The method of claim 10, further comprising creating a non-visible iframe.

19. A non-transitory computer readable information storage media having stored thereon instructions, that if executed by one or more processors, cause to be performed the method of claim 1.

20. A plurality of means adapted to perform the steps of claim 10.

21. The method of claim 10, wherein the one or more actions include showing a video in a full-screen or substantially full-screen mode in either the web browser or on a display.
